(19) United States
(12) Patent Application Publication
(10) Pub. No.: US 2022/0067622 A1
(43) Pub. Date: Mar. 3, 2022

(54) SYSTEMS AND METHODS FOR AUTOMATING PRODUCTION INTELLIGENCE ACROSS VALUE STREAMS USING INTERCONNECTED MACHINE-LEARNING MODELS

(71) Applicant: Noodle Analytics, Inc., San Francisco, CA (US)

(72) Inventor: Sivantha Devarakonda, San Ramon, CA (US)

(21) Appl. No.: 17/002,547

(22) Filed: Aug. 25, 2020

(51) Int. Cl. G06Q 10/06; G06Q 50/04; G06Q 10/08; G05B 13/02; G07C 3/08

(52) U.S. Cl. CPC G06Q 10/06375; G06Q 50/04; G06Q 10/067; G07C 3/08; G06Q 10/06395; G05B 13/028; G06Q 10/087

(57) ABSTRACT

Disclosed herein are systems and methods for automating production intelligence across value streams using interconnected machine-learning models. An embodiment of a system includes an upstream machine-learning model corresponding to each of one or more upstream entity in a production value stream of a product; a final-assembly machine-learning model corresponding to a final-assembly process in the production value stream of the product; a causal-analysis machine-learning model for the production value stream of the product; an action-and-alert process for the production value stream of the product; and an implementation interface for the production value stream of the product. The upstream machine-learning models and the final-assembly machine-learning model are interconnected to provide product-throughput prediction for the product. The causal-analysis machine-learning model infers causal factor for the product-throughput prediction, and alerts and/or recommended actions are issued to the implementation interface.

### CROSS-REFERENCE TO RELATED APPLICATIONS

U.S. Provisional Patent Application No. 62/787,013, filed Dec. 31, 2018 and entitled “Automated Supply Chain Intelligence system,” is hereby incorporated herein by reference in its entirety.

### BACKGROUND

Original equipment manufacturers (OEMs) deploy discrete and continuous manufacturing systems and processes to manufacture products that are technically complex and dependent on production value streams, a term that is used broadly in this disclosure to also encompass terms such as supply chains, value chains, and the like. Various nodes in a production value stream can pertain to providing raw materials, processed materials, processing one or more components (e.g., parts) of an end product, one or more sub-assemblies or sub-processes (e.g., modules) of an end product, and/or the like. Such complex systems and processes cause high variability in production of the end product. This high variability can result in negative consequences such as failure to deliver on customer contracts (e.g., service levels) within time, cost, and/or quality parameters, lost revenue due to unmet demand, etc. This in turn can lead to loss of sales, fines, liquidation of inventory due to quality rejection among other possible reasons, and/or other problems.

### BRIEF DESCRIPTION OF THE DRAWINGS

A more detailed understanding may be had from the following description, which is presented by way of example in conjunction with the following drawings, in which like reference numerals are used across the drawings in connection with like elements.

FIG. 1 illustrates an example automated production intelligence system, in accordance with at least one embodiment.

FIG. 2 illustrates an example production value stream, in accordance with at least one embodiment.

FIG. 3 illustrates a representative entity hierarchy in a production value stream, in accordance with at least one embodiment.

FIG. 4 illustrates an example method, in accordance with at least one embodiment.

FIG. 5 illustrates an example data representation, in accordance with at least one embodiment.

FIG. 6 illustrates a nested delay hierarchy, in accordance with at least one embodiment.

FIG. 7 illustrates an example method, in accordance with at least one embodiment.

FIG. 8 illustrates an embodiment of a data-acquisition-and-preparation process of the method of FIG. 7, in accordance with at least one embodiment.

FIG. 9 illustrates a schematic representation of a system, in accordance with at least one embodiment.

FIG. 10 illustrates an example graph of predicted throughput of a production value stream, in accordance with one embodiment.

FIG. 11 illustrates an example graph of production risk based on a planned schedule, in accordance with at least one embodiment.

FIG. 12 illustrates an example graph of predicted production completion time by unit, in accordance with at least one embodiment.

FIG. 13 illustrates an example machine-learning framework, in accordance with at least one embodiment.

FIG. 14 illustrates examples of data items that can be used as features for training one or more machine-learning models, in accordance with at least one embodiment.

FIG. 15 illustrates an example method, in accordance with at least one embodiment.

FIG. 16 illustrates a machine in the form of a computer system within which a set of instructions may be executed for causing the machine to perform any one or more of the methodologies discussed herein, in accordance with at least one embodiment.

FIG. 17 illustrates a software architecture within which one or more embodiments of the present disclosure may be implemented, in accordance with at least one embodiment.

### DETAILED DESCRIPTION

Disclosed herein are systems and methods for automating production intelligence across value streams using interconnected machine-learning models.

One example embodiment takes the form of a system that includes an upstream machine-learning model corresponding to each of one or more upstream entities in a production value stream of a product; an end-production machine-learning model that learns and represents and end-to-end production process in a value stream for complex manufactured products; a causal-analysis machine-learning model for the production value stream of the product; an action-and-alert process for the production value stream of the product; a recommendation system to sequence the production flows based on the current state of the value stream, so operators can schedule production processes, machines and workflows to optimize the throughput of the value-stream while minimizing the overall operational costs or any other associated lost revenue; and an implementation interface for the production value stream of the product.

Another example embodiment takes the form of a system that includes an upstream machine-learning model corresponding to each of one or more upstream entities (or process steps) in a production value stream of a product; a final-assembly (or process) machine-learning model corresponding to a final-assembly process in the production value stream of the product; a causal-analysis machine-learning model for the production value stream of the product; an action-and-alert process for the production value stream of the product; and an implementation interface for the production value stream of the product.

In an embodiment, each upstream machine-learning model is configured to: receive one or more operational metric corresponding to the respective upstream entity (or process step); generate, based on at least the received one or more operational metric corresponding to the respective upstream entity, upstream delay predictions corresponding to the respective upstream entity; and provide the upstream delay predictions to both the final-assembly machine-learning model and the causal-analysis machine-learning model.

In an embodiment, the final-assembly machine-learning model is configured to: receive one or more operational metric corresponding to the final-assembly process; receive the upstream delay predictions from the respective upstream machine-learning models; generate, based on at least the received one or more operational metric corresponding to the final-assembly process and the upstream delay predictions from the respective upstream machine-learning models, product-throughput prediction for the product; and provide the (finished/final) product-throughput prediction to the causal-analysis machine-learning model.

In an embodiment, the causal-analysis machine-learning model is configured to: receive the upstream delay predictions (component, entity or process step hierarchies) from the respective upstream machine-learning models; receive the finished good/product-throughput prediction from the final-assembly machine-learning model; identify, based on at least the received upstream delay predictions from the respective upstream machine-learning models and the product-throughput prediction from the final-assembly machine-learning model, one or more causal factors for one or both of the upstream delay predictions and the product-throughput prediction; and provide the identified one or more causal factor to the action-and-alert process.

In an embodiment, the action-and-alert process is configured to: receive the identified one or more causal factor from the causal-analysis machine-learning model and predictions from the various (throughput and delay) models; generate, based on at least the identified one or more causal factors, one or both of one or more alerts and one or more recommended actions; and providing the one or both of one or more alerts and one or more recommended actions to the implementation interface.

In an embodiment, the implementation interface is configured to: receive the one or both of one or more alerts and one or more recommended actions from the action-and-alert process; obtain and process response to the one or both of one or more alerts and one or more recommended actions; and provide data reflective of the response to one or more of one or more of the upstream entities, the final-assembly process, one or more of the upstream machine-learning models, and the final-assembly machine-learning model.

Another embodiment takes the form of a method that includes receiving, by a causal-analysis machine-learning model for a production value stream of a product, upstream delay predictions from each of a plurality of upstream machine-learning models, each upstream machine-learning model corresponding to a respective upstream entity in the production value stream. The method further includes receiving, by the causal-analysis machine-learning model, product-throughput prediction from a final-assembly machine-learning model for the production value stream. The method also includes identifying, by the causal-analysis machine-learning model, and based on at least the received upstream delay predictions and the product-throughput prediction, one or more causal factors for one or both of the upstream delay predictions and the product-throughput prediction. The method also includes providing, by the causal-analysis machine-learning model, the identified one or more causal factors to an action-and-alert process for the production value stream. The method further includes generating, by the action-and-alert process, and based on at least the identified one or more causal factors, one or both of one or more alerts and one or more recommended actions. The method also includes providing, by the action-and-alert process, the one or both of one or more alerts and one or more recommended actions to an implementation interface for the production value stream.

Another embodiment takes the form of a system that includes a communication interface, a hardware processor, and data storage that contains instructions executable by the hardware processor for carrying out the functions listed in the preceding paragraph. Still another embodiment takes the form of a computer-readable medium (CRM) containing instructions executable by a hardware processor for carrying out at least those functions.

Furthermore, a number of variations and permutations of the above-listed embodiments are described herein, and it is expressly noted that any variation or permutation that is described in this disclosure can be implemented with respect to any type of embodiment. For example, a variation or permutation that is primarily described in this disclosure in connection with a method embodiment could just as well be implemented in connection with a system embodiment and/or a CRM embodiment. Furthermore, this flexibility and cross-applicability of embodiments is present in spite of any slightly different language (e.g., process, method, steps, functions, sets of functions, and/or the like) that is used to describe and/or characterize such embodiments.

OEMs typically prefer to be able to accurately predict throughput of a production value stream, and to understand causes for variability and take corrective (i.e., corrective and/or preventative) action at appropriate times, among other goals. OEMs also often strive to prioritize corrective actions in order to meet financial, operational, and/or other objectives, including objectives related to meeting demand and service levels, customer satisfaction, maintaining of branding and/or market position, measuring the effectiveness of a production value stream, profitability and/or other financial targets, and/or reducing waste and liquidation of material to improve efficiency.

Included among the various aspects of the present disclosure are automated systems and methods that utilize multiple, interconnected machine-learning models executing on hardware. One or more of these machine-learning models correspond to respective nodes—in a production value stream of a given product—that are upstream from the production process that ultimately produces the product for sale to wholesalers, retailers, end consumers, and/or the like. As used herein, “upstream” refers to entities, process steps, nodes, and/or the like that are earlier (i.e., further away, process-wise, from product completion and delivery to, e.g., a customer) in the production value stream than an end product or end-product production process. Some examples of such products include engines, cars, elevators, industrial equipment, and the like. Another of these machine-learning models corresponds to the final-assembly process of the product, and makes predictions for outcomes such as product throughput based on both (i) quantified risk predictions, metrics, and/or the like generated by the one or more upstream machine-learning models and (ii) quantified risk predictions, metrics, and/or the like related to the final-assembly process of the product. Embodiments of the present systems and methods generate one or more alerts and/or one or more recommended actions that pertain to one or more upstream nodes in the production value stream and/or the final-assembly process of the product.

A given machine-learning model can execute as part of a machine-learning program being executed using hardware such as one or more computers, computer systems, servers, and/or the like. A given machine-learning program can incorporate one machine-learning model or a plurality of machine-learning models. By executing upstream and end-production machine-learning models, one or more disclosed embodiments provide automated production and inbound (i.e., upstream) intelligence and recommendations to improve (e.g., optimize) manufacturing throughput using interconnected machine-learning models. Some embodiments provide intelligence for discrete and/or continuous industrial manufacturing operations, to estimate predicted production capacity based on disparate data sources such as, e.g., key performance indicators (KPIs), measurements, and/or actions across the production value stream to meet, e.g., one or more of the objectives listed above.

One or more disclosed embodiments involve prediction of production capacity for industrial manufacturing operations (both continuous and discrete) based on disparate data sources. Some embodiments involve receiving production data for multiple levels of a production value stream. This production data can include input signals related to a variety of production components, located across the production value stream. The input signals may relate to observed production operational metrics and plans derived from the production value stream. As examples, production planning and process data may be received for the production of raw materials, parts, components, sub-assemblies, and/or modules at specific plants and tagged to specific production lines and resources. Based on the observed production operational metrics and planned production certain operational metrics are predicted. The predictions may be performed by interconnected machine-learning models. In at least some embodiments, the machine-learning models are trained based on historical observations of production operational metrics and latest production scheduling and plans. Some embodiments involve inferring, using the machine-learning models and the observed production operational metrics, causal factors that impact the predicted production operational metrics. Some embodiments also involve generation of prognostic alerts, action recommendations based on simulation and generative models, and/or predicted value impacts for a plurality of actions related to the operation of the production value stream. As used herein, “causal factors” include those factors that are elements that contribute in some manner to (e.g., determine) the outcome of a process.

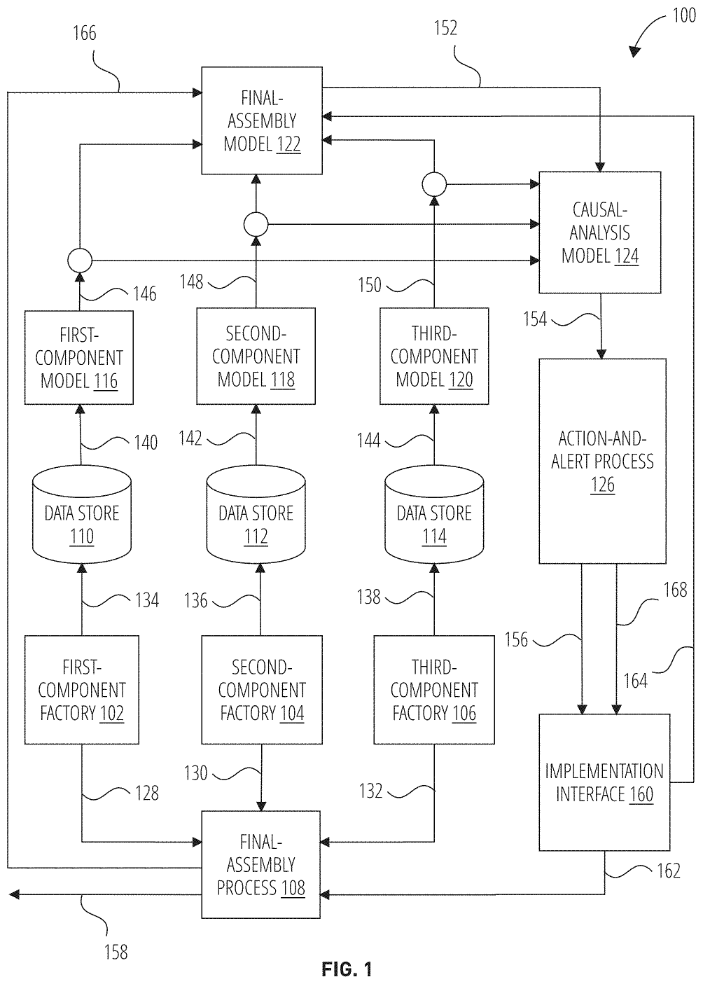

FIG. 1 illustrates an automated production intelligence system 100, in accordance with at least one example embodiment. It is noted that not all of the elements that are depicted in FIG. 1 are necessarily elements of the automated production intelligence system 100. For example, among the elements that are depicted in FIG. 1 are a first-component factory 102, a second-component factory 104, and a third-component factory 106. In at least one embodiment, these factories are not elements of the automated production intelligence system 100. In this example embodiment, the first-component factory 102, the second-component factory 104, and the third-component factory 106 produce a first component, a second component, and a third component, respectively, of an example product that is produced in a final-assembly process 108. The first-component factory 102 delivers the first component to the final-assembly process 108 as shown at first-component deliveries 128. The second-component factory 104 delivers the second component to the final-assembly process 108 as shown at second-component deliveries 130. And the third-component factory 106 delivers the third component to the final-assembly process 108 as shown at third-component deliveries 132.

The final-assembly process 108 could take place at a factory or other facility that is physically separate from each of the first-component factory 102, the second-component factory 104, and the third-component factory 106. In some embodiments, one or more of the first-component factory 102, the second-component factory 104, and the third-component factory 106 could be co-located with the final-assembly process 108. The depiction in FIG. 1 is generally of a discrete manufacturing process, though the automated production intelligence system 100 could also or instead be used in connection with a continuous manufacturing process. One result of the final-assembly process 108 is the production of a product 158.

In addition to providing components, the three component factories that are depicted in FIG. 1 also generate operational-metric data pertaining to their respective operations. The first-component factory 102 generates and transmits first-component operational metrics 134 to a data store 110. The second-component factory 104 generates and transmits second-component operational metrics 136 to a data store 112. And the third-component factory 106 generates and transmits third-component operational metrics 138 to a data store 114. Examples of the types of operational metrics that could be reflected in the first-component operational metrics 134, the second-component operational metrics 136, and/or the third-component operational metrics 138 are described below. These operational metrics could include observed operational metrics with respect to the production of the various components at the various factories.

Each of the data stores provides historical data relevant to the component produced by the corresponding factory. This historical data can include data items such as raw materials used, amount of material used, manufacturing steps, configuration of the manufacturing steps, actual duration of the manufacturing steps, quality metrics, energy expense, labor expense, production capacity of equipment, time taken to transport raw materials or parts and/or any one or more other data items deemed suitable by those of skill in the art for a given implementation. The data store 110 provides first-component historical data 140 to a first-component machine-learning model 116. The data store 112 provides second-component historical data 142 to a second-component machine-learning model 118. And the data store 114 provides third-component historical data 144 to a third-component machine-learning model 120. The first-component machine-learning model 116, the second-component machine-learning model 118, and the third-component machine-learning model 120 are examples of what are referred to herein as upstream machine-learning models. Each of them corresponds with a node that is upstream of the final-assembly process 108 in the production value stream that is depicted in FIG. 1. In at least one embodiment, each of the first-component historical data 140, the second-component historical data 142, and the third-component historical data 144 includes historical data pertaining to the corresponding operational metrics of the corresponding factory.

The three example upstream machine-learning models that are depicted in FIG. 1 are examples of upstream machine-learning models that correspond to providers of components that are later combined into an end product. This is one example of a type of upstream machine-learning model that can be deployed in embodiments of the present disclosure. Other examples include machine-learning models deployed in connection with raw-material providers, processed-material providers, sub-assembly (e.g., module) providers that, e.g., combine parts into sub-assemblies that are ultimately further combined into an end product, process steps, and/or the like. Other examples include machine-learning models deployed in connection with process manufacturing raw-material providers, processed-material providers, sub-assembly (e.g., module) providers that, e.g., combine parts into sub-assemblies that are ultimately further combined into an end product, process steps, and/or the like. Furthermore, machine-learning models can be deployed in connection with one or more of finished goods, location and/or geography (e.g., of manufacturing plants, maintenance, repair and operations (MRO) providers, shops, operators, product classes and/or groups, suppliers, vendors, distributors, customers, and/or the like. In some embodiments, manufacturing throughput (e.g., output) levels are predicted at least in part by measuring various operational metrics (e.g., time to completion) and/or actions at dependent process steps across an entity hierarchy and/or production value stream, and estimating a measure of risk (e.g., of delay) at forward-looking intervals (e.g., days, months, quarters, and/or the like). In at least one embodiment, the above-mentioned historical data includes data reflecting such measured operational metrics.

Moreover, each of the upstream machine-learning models provides predictions to both a final-assembly machine-learning model 122 and a causal-analysis machine-learning model 124. These predictions could relate to expected production times, expected delay times, expected production amounts, etc. of raw materials, parts, components, subassemblies, process steps, and/or the like. The first-component machine-learning model 116 provides first-component predictions 146, the second-component machine-learning model 118 provides second-component predictions 148, and the third-component machine-learning model 120 provides third-component predictions 150. Any machine-learning model described herein can be implemented using a machine-learning program executing on one or more hardware platforms, and can be operated as a standalone machine-learning model and/or be combined with one or more other machine-learning models in various different embodiments.

The final-assembly machine-learning model 122 receives the first-component predictions 146 from the first-component machine-learning model 116, the second-component predictions 148 from the second-component machine-learning model 118, and the third-component predictions 150 from the third-component machine-learning model 120. Furthermore, the final-assembly machine-learning model 122 also receives end-product operational metrics 166 from the final-assembly process 108, as well as implementation feedback 164 from an implementation interface 160. The implementation interface 160 could be a standalone computer system or a functional part of another computer system. The implementation interface 160 could include a hardware processor, data storage, instructions, a user interface, one or more machine interfaces, and/or any one or more other components deemed suitable by those of skill in the art for performing the functions described herein as being carried out by the implementation interface 160. Thus, the implementation interface 160 could be a module, system, and/or other arrangement equipped, programmed, and configured to carry out such functions.

The final-assembly machine-learning model 122 generates and transmits product-level predictions 152 to the causal-analysis machine-learning model 124. The product-level predictions 152 could relate to expected production levels, expected production amounts, expected production times, expected production delays, expected production costs, and/or any one or more other types of product-level predictions 152 deemed suitable by those of skill in the art for a given implementation. As described, the causal-analysis machine-learning model 124 also receives the first-component predictions 146 from the first-component machine-learning model 116, the second-component predictions 148 from the second-component machine-learning model 118, and the third-component predictions 150 from the third-component machine-learning model 120. Based on all of those sets of predictions, the causal-analysis machine-learning model 124 infers causal factor of one or more of the predictions generated by one or more of the first-component machine-learning model 116, the second-component machine-learning model 118, the third-component machine-learning model 120, and the final-assembly machine-learning model 122. The causal-analysis machine-learning model 124 provides identified causal factor 154 to an action-and-alert process 126. Based at least in part on the identified causal factor 154, the action-and-alert process 126 generates alerts 156 and recommended actions 168, and transmits both to the implementation interface 160, which could include one or more user interfaces for human users (e.g., graphical user interfaces (GUIs), audiovisual interfaces, and/or the like) and/or one or more automated interfaces for carrying out automated processing of the alerts 156 and recommended actions 168.

Operation and output (e.g., the identified causal factor 154) of the causal-analysis machine-learning model 124 provide causal insight into factors that drive delays and/or pose a relatively high risk to product throughput at future intervals at multiple levels of granularity and/or hierarchy (e.g., product category, bill of materials (BOM), modules, parts, suppliers, process, etc.) The alerts 156 represent prognostic alerts so that users may take corrective action based on this causal insight. In at least one embodiment, the alerts 156 are based on adaptive, learning-based root-causal analysis rather than static rules. In an embodiment, the alerts 156 are messages that convey to their one or more recipients what to focus on, aimed at evoking a considered, accurate response from the one or more recipients.

Moreover, the recommended actions 168 in some embodiments are prioritized based on quantified risk (e.g., based on minimizing a cost function, maximizing a reward function, and/or the like, where such function could take into account upstream materials, parts, components, process steps, and/or the like). The quantified risk can be based on operational measurements across the production value stream, relating to, e.g., upstream material deliveries, modules, process subsystems, operator efficiency, etc. Action-sequence recommendations can be generated at least in part by minimizing a cost function that incorporates operational and financial metrics such as revenue, profits, operating margin, lost sales, penalties due to late deliveries, expedite costs, impact on new contracts due to non-compliance, inventory-holding costs, fill rates, production quantity, and/or the like. In at least one embodiment, the recommended actions 168 are contextualized to users based on the users' respective roles, as well as fed back into execution and/or transactional systems to adaptively re-plan operations.

The implementation interface 160 generates implementation commands 162 and transmits the implementation commands 162 to the final-assembly/production process 108 in order to alter one or more operating parameters of the final-assembly process 108. In some embodiments, although not pictured in FIG. 1, the implementation interface 160 also or instead generates commands for transmission to one, some, or all of the upstream nodes (e.g., the first-component factory 102, the second-component factory 104, and/or the third-component factory 106), in order to alter one or more operating parameters of the operations there. Additionally, the implementation interface 160 generates and transmits implementation feedback 164 to the final-assembly machine-learning model 122, to further refine and improve the operation of the final-assembly machine-learning model 122.

Furthermore, although not pictured in FIG. 1, in some embodiments, the implementation interface 160 generates and transmits implementation feedback to one, some, or all of the upstream machine-learning models (e.g., the first-component machine-learning model 116, the second-component machine-learning model 118, and/or the third-component machine-learning model 120), to refine and improve their respective performance and learn adaptively. In various embodiments, the implementation commands 162 and the implementation feedback 164 reflect information such as one or more of the alerts 156 that were acted upon (or not acted upon) and/or one or more of the recommended actions 168 that were taken (or not taken) by one or more human users and/or one or more automated processes. In at least one embodiment, the implementation feedback 164 is associated with tracking and storing user and/or system actions in real time and measuring associated costs and/or rewards across a production value stream.

The present systems and methods provide an interconnected system of intelligence across a production value stream. The outputs and predictions from upstream modules are synchronized with the outputs and inputs in downstream modules. This approach is based in part on a recognition that material delays propagate to production delays, which then propagate to inventory shortages, which in turn propagate to fill-rate issues, which represents a service-level risk. The present systems and methods synchronize inputs and outputs across the entire landscape of the production value stream.

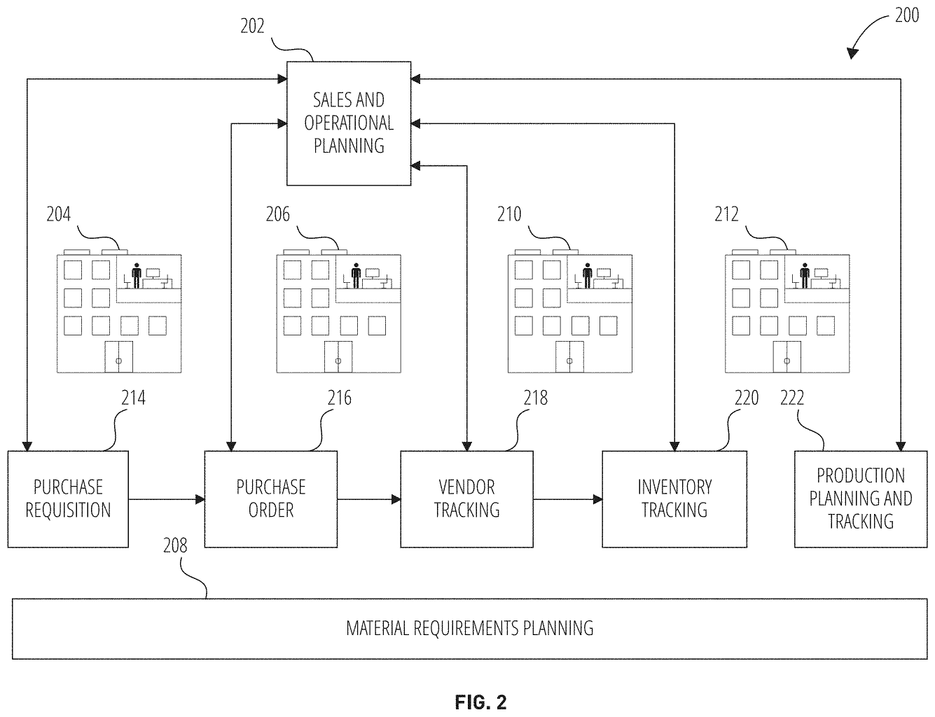

FIG. 2 illustrates an example production value stream 200, in accordance with at least one embodiment. In the production value stream 200, a sales-and-operational-planning process 202 communicates with a purchase-requisition process 214, a purchase-order process 216, a vendor-tracking process 218, an inventory-tracking process 220, and a production-planning-and-tracking process 222. Moreover, each of the purchase-requisition process 214, the purchase-order process 216, the vendor-tracking process 218, the inventory-tracking process 220, and the production-planning-and-tracking process 222 influence a material-requirements-planning process 208. Four example suppliers are shown: a supplier 204, a supplier 206, a supplier 210, and a supplier 212, each of which may provide respective materials, parts, components, modules, subassemblies, and/or the like. One or more of the supplier 204, the supplier 206, the supplier 210, and the supplier 212 may provide materials based on the material-requirements-planning process 208.

Moreover, as indicated by the multiple horizontal arrows in FIG. 2, the purchase-requisition process 214 may drive the purchase-order process 216, which in turn may drive the vendor-tracking process 218. The vendor-tracking process 218 may drive the inventory-tracking process 220. And although not pictured in FIG. 2, the production value stream 200 may also include other functions such as a receipting function and a shipping function, among other possible functions.

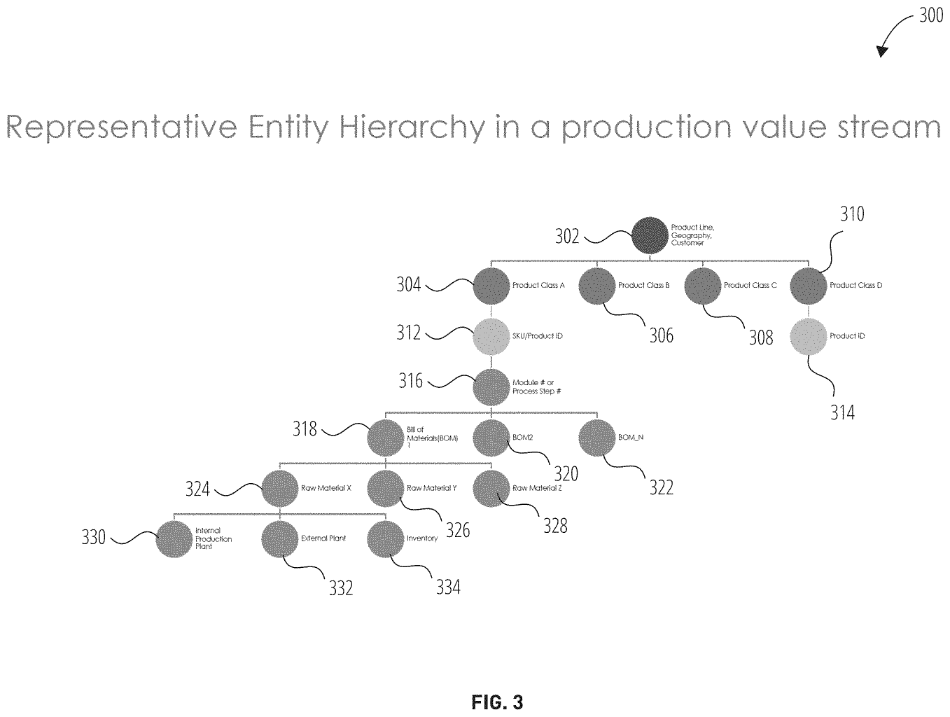

FIG. 3 illustrates a representative entity hierarchy 300 in a production value stream, in accordance with at least one embodiment. The entity hierarchy 300 includes a top level 302, which could represent a product line, a geographical area, or a particular customer, as examples. The second level includes four example product classes: a product class 304, a product class 306, a product class 308, and a product class 310. In the third level, by way of example, there is an SKU/product ID 312 under the product class 304, and there is an example product ID 314 under the product class 310. SKU is an abbreviation for stock keeping unit, which in at least one embodiment is an (e.g., alphanumeric) identifier of a product that facilitates the tracking of the product for purposes such as inventory management.

Further by way of example, under the SKU/product ID 312 in the entity hierarchy 300 is a module or process-step number 316, which may relate to a component module or subassembly, or perhaps an intermediate step in the production, of a product associated with the SKU/product ID 312. Furthermore, although not explicitly depicted in FIG. 3, there could be, below the SKU/product ID 312 and above the module or process-step number 316 several levels such as a production-plant node above production lines and/or or machines or other modules. Numerous other variations of the entity hierarchy 300 are possible as well, as will be appreciated by those of skill in the relevant arts.

Under the module or process-step number 316 is a number of bills of material: a bill of materials 318, a bill of materials 320, and a bill of materials 322, where the latter is labeled BOM_N in FIG. 3 to indicate that there could be any number of bills of material. Furthermore, under the bill of materials 318 are a raw material 324, a raw material 326, and a raw material 328, though any number of raw materials could be shown under a given bill of materials. Lastly, as an example, under the raw material 324 there is shown options for sourcing the raw material 324. The depicted options are an internal production plant 330, an external plant 332, and inventory 334. Any one or more of these data items could be included in the historical data used by one or more of the machine-learning models.

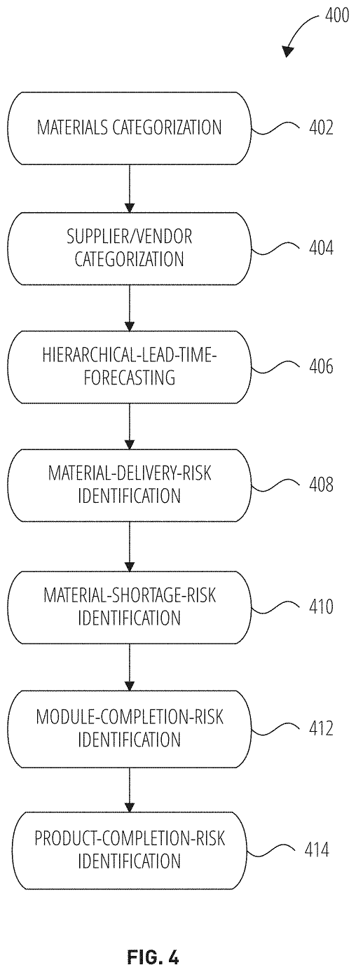

FIG. 4 illustrates an example method 400 for identifying production risks (e.g., production-delay risks), in accordance with at least one embodiment. The method 400 begins with a materials-categorization process 402 and a supplier/vendor-categorization process 404. In the materials-categorization process 402, each of various materials may be assigned to one or a plurality of materials categories, where materials in a given category are similar to one another according to one or more properties (e.g., chemical composition, hardness, typical uses, lead time, cost/price, complexity, volume, quality, yield, demand, and/or the like). In the supplier/vendor-categorization process 404, each of multiple suppliers and/or vendors may be assigned to one of a plurality of supplier/vendor categories, again where the suppliers and/or vendors in a given category are similar to one another according to one or more properties (e.g., lead time, cost/price, complexity, volume, reliability metrics, quality metrics, yield metrics, commitment accuracy, on-time delivery performance, capacity, work in progress (WIP) metrics, type of material or part supplied, geographic location, entity size, and/or the like).

The method 400 then continues with a hierarchical-lead-time-forecasting process 406. In an example scenario, a company may hire a vendor to produce a part for the company, where that part is to be incorporated into a product. The vendor may initially indicate that it will take them a certain amount of time to produce the part. In actuality, it may take them a longer amount of time to actually produce the part. If the company wants to truly understand how much time will be required to produce the product, the company may conduct a hierarchical-lead-time-forecasting process 406 in which they traverse through a hierarchy of lead times and dependencies, and come up with an aggregation of the time it takes the various participants in the supply chain to acquire their materials, produce their parts, provide their parts downstream, and so forth.

The hierarchical-lead-time-forecasting process 406 may be a process of traversing such a hierarchy to develop an estimate of overall lead time for a product. Lead times are aggregated across a product-compiling process, taking dependencies into account, to arrive at an overall lead time to produce a product. In an embodiment, a machine-learning model could takes as inputs projected lead times and actual lead times. Over time, the model may learn how lead times are changing. A system may include both a measurement system and a learning/predictive system and learn over time what actual lead times are to produce a finished product across the hierarchy. Different vendors may demonstrate different lead times over time, and the model would learn this (based on. e.g., historical performance and other exogenous factors like location, vendor category, macro-economics, economic climate, regulatory factors etc.) and take this into account when estimating an overall lead time for a product in different supply-chain options.

The method 400 continues with a material-delivery-risk-identification process 408, in which one or more risks are identified with respect to delays in delivery of one or more materials to one or more locations at which those materials are needed as part of a production value stream. Next in the method 400 is a material-shortage-risk-identification process 410, which quantifies one or more risks associated with the possible occurrence of one or more shortages (e.g., stock-out events) of one or more materials that are used in the production value stream.

The method 400 then continues with a module-completion-risk-identification process 412, which involves quantification of one or more risks associated with delays occurring in the assembly, production, and/or the like of one or more modules, subassemblies, and/or the like that make up one or more parts of the production value stream of a given product. Further, the method 400 includes a product-completion-risk-identification process 414, which quantifies risks associated with production of an end product in the production value stream. In at least one embodiment, the product-completion-risk-identification process 414 incorporates one or more of the risks determined in one or more of the materials-categorization process 402, the supplier/vendor-categorization process 404, the material-delivery-risk-identification process 408, the material-shortage-risk-identification process 410, and the module-completion-risk-identification process 412.

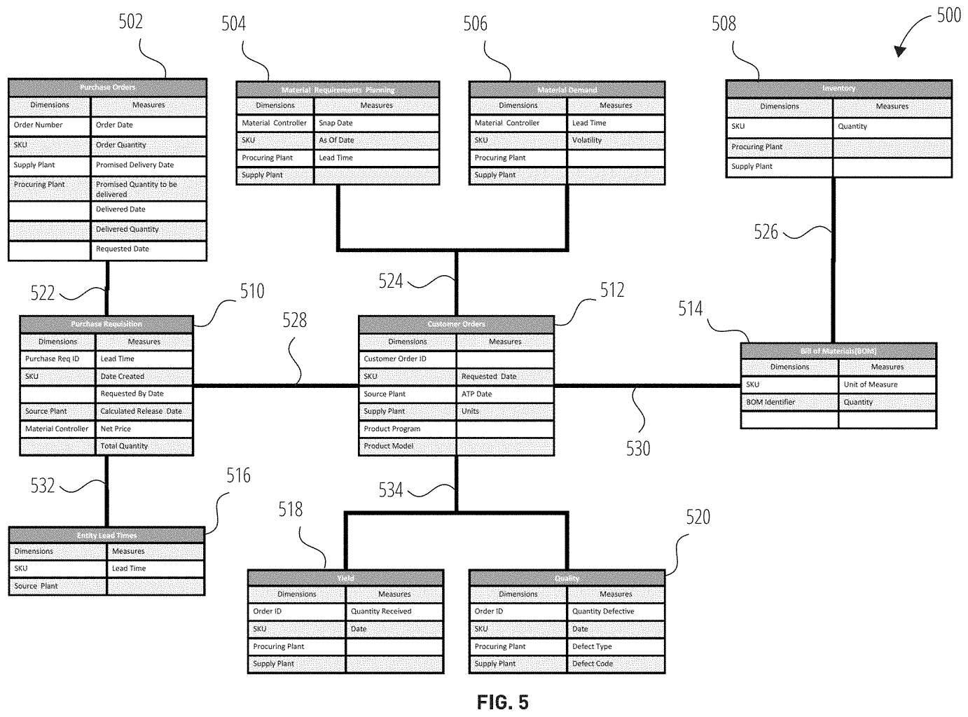

FIG. 5 illustrates an example data representation 500, in accordance with one embodiment. The data representation 500 includes purchase-order data 502, material-requirements-planning data 504, material-demand data 506, inventory data 508, purchase-requisition data 510, customer-orders data 512, bill-of-materials data 514, entity-lead-time data 516, yield data 518, and quality data 520. Each of those categories of data include a dimensions subsection (e.g., column) and a measures subsection (e.g., column). The data representation 500 could represent a relational database structure for use by an automated production intelligence system in connection with a production value stream. Any of the data items represented in FIG. 5 could correspond to features that are utilized by any one or more of the machine-learning models described herein.

In the purchase-order data 502, the dimensions subsection includes order number. SKU, supply plant, and procuring plant, while the measures subsection includes order date, order quantity, promised delivery date, promised quantity to be delivered, delivered date, delivered quantity, and requested date. As indicated at 522, in the data representation 500, the purchase-order data 502 is related to the purchase-requisition data 510.

In the material-requirements-planning data 504, the dimensions subsection includes material controller, SKU, procuring plant, and supply plant, while the measures subsection includes snap date, as-of date, and lead time. As indicated at 524, in the data representation 500, the material-requirements-planning data 504 is related to the material-demand data 506 and the customer-orders data 512.

In the material-demand data 506, the dimensions subsection includes material controller, SKU, procuring plant, and supply plant, while the measures subsection includes lead time and volatility. As indicated at 524, in the data representation 500, the material-demand data 506 is related to the material-requirements-planning data 504 and the customer-orders data 512.

In the inventory data 508, the dimensions subsection includes SKU, procuring plant, and supply plant, while the measures subsection includes quantity. As indicated at 526, in the data representation 500, the inventory data 508 is related to the bill-of-materials data 514.

In the purchase-requisition data 510, the dimensions subsection includes purchase-requisition ID, SKU, source plant, and material controller, while the measures subsection includes lead time, date created, requested-by date, calculated release date, net price, and total quantity. As shown at 522, 528, and 532, respectively, in the data representation 500, the purchase-requisition data 510 is related to the purchase-order data 502, the customer-orders data 512, and the entity-lead-time data 516.

In the customer-orders data 512, the dimensions subsection includes customer order ID, SKU, source plant, supply plant, product program, and product model, while the measures subsection includes requested date, ATP date, and units. As shown at 524, 528, 530, and 534, respectively, in the data representation 500, the customer-orders data 512 is related to the material-requirements-planning data 504 and the material-demand data 506, the purchase-requisition data 510, the bill-of-materials data 514, and the yield data 518 and the quality data 520.

In the bill-of-materials data 514, the dimensions subsection includes SKU and bill-of-materials (BOM) identifier, while the measures subsection includes unit of measure and quantity. As shown at 526 and 530 respectively, in the data representation 500, the bill-of-materials data 514 is related to the inventory data 508 and the customer-orders data 512.

In the entity-lead-time data 516, the dimensions subsection includes SKU and source plant, while the measures subsection includes lead time. As shown at 532, in the data representation 500, the entity-lead-time data 516 is related to the purchase-requisition data 510.

In the yield data 518, the dimensions subsection includes order ID, SKU, procuring plant, and supply plant, while the measures subsection includes quantity received and date. As shown at 534, in the data representation 500, the yield data 518 is related to the customer-orders data 512 and the quality data 520.

In the quality data 520, the dimensions subsection includes order ID, SKU, procuring plant, and supply plant, while the measures subsection includes quantity defective, date, defect type, and defect code. As shown at 534, in the data representation 500, the quality data 520 is related to the customer-orders data 512 and the yield data 518.

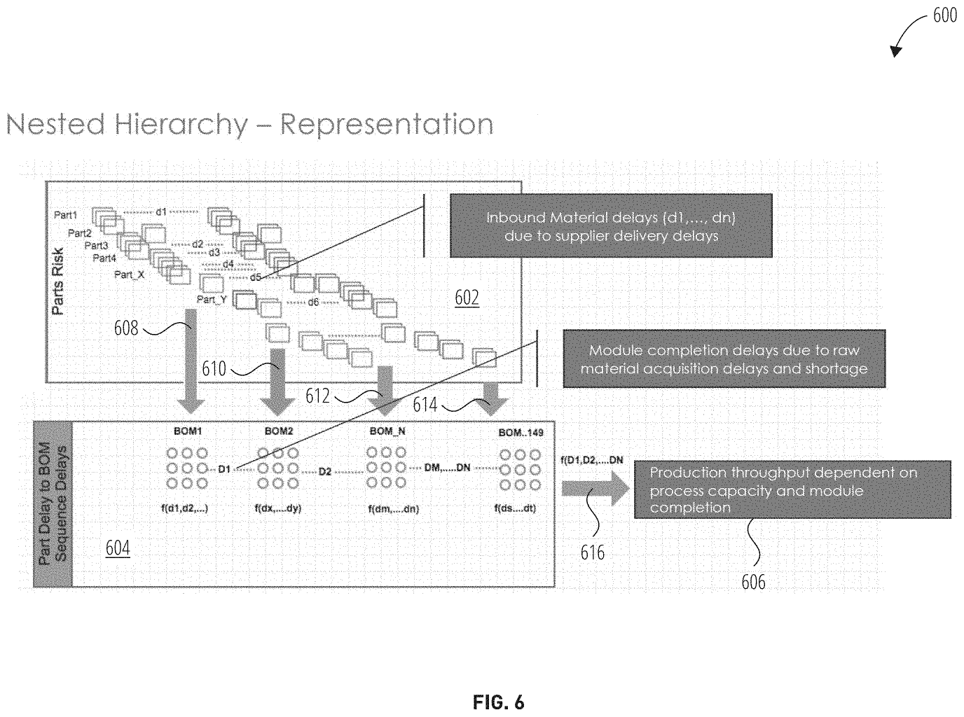

FIG. 6 illustrates a nested delay hierarchy 600, in accordance with at least one embodiment. The nested delay hierarchy 600 shows how delays in one part of a production value stream can propagate into causing one or more delays in one or more downstream parts of the production value stream. As shown in FIG. 6, the nested delay hierarchy 600 generally includes inbound-material delays 602, module-completion delays 604, and end-product-completion delay 606.

The inbound-material delays 602 are represented in FIG. 6 by the symbols {d1 . . . dn} to represent an arbitrary number n of inbound-material delays 602, which could be due to supplier delivery delays. The inbound-material delays 602 are shown as corresponding to various example parts that are labeled Part1, Part2, . . . Part_X, Part_Y to represent an arbitrary number of parts. While parts are depicted as example inbound materials in FIG. 6, the inbound-material delays 602 could relate in some cases to components, raw materials, and/or the like. As a general matter, material allocation challenges are exacerbated by unplanned supplier delays and shortages.

As indicated generally at 608, 610, 612, and 614, the module-completion delays 604 are affected (e.g., caused, exacerbated, etc.) by the inbound-material delays 602, because the associated modules are dependent upon the parts that are associated with the inbound-material delays 602. As stated in FIG. 6, the module-completion delays 604 are due to raw material acquisition delays and shortages (i.e., the inbound-material delays 602). In the module-completion delays 604, the particular delays are represented by the symbols {D1, D2, . . . , DM, DN, . . . } to indicate an arbitrary number of module-completion delays 604. Each of the module-completion delays 604 is associated with a module having a bill of materials that is numbered to correspond with the associated one of the module-completion delays 604 (i.e., BOM1 is associated with a module that has an associated delay D1, etc.). Each of the module-completion delays 604 is shown to be a function of a set of the inbound-material delays 602 that correspond to the parts on the bill of materials for that particular module. For example, the module-completion delay D1 is a function of a set {d1, d2, . . . } of the inbound-material delays 602.

As indicated generally at 616, the end-product-completion delay 606 is affected by the module-completion delays 604, which as stated above are in turn affected by the inbound-material delays 602. The delays are nested and the effects propagate downstream in the production value stream. As stated in FIG. 6, the production throughput is dependent on process capacity and module completion, which are factors that contribute to the module-completion delays 604. The end-product-completion delay 606 is shown as a function of the multiple module-completion delays 604, expressed as f(D1, D2, . . . DN).

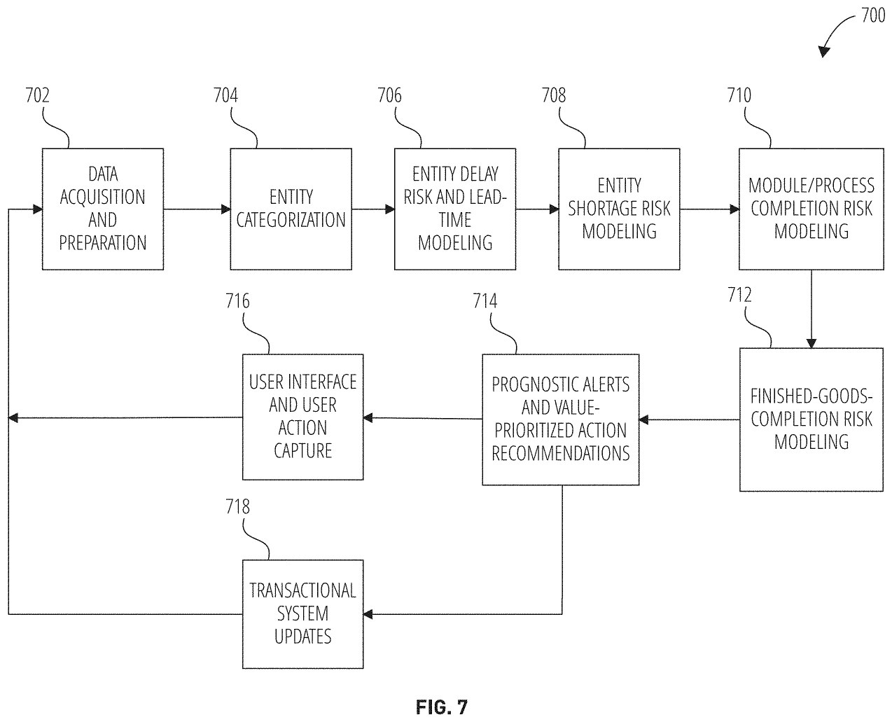

FIG. 7 illustrates an example method 700 for identifying and addressing production risks (e.g., production-delay risks) that may be performed in one or more embodiments. The method 700 is described herein as a collection of processes, and can also be thought of as a high-level system schematic or overview for developing and using risk modeling that may be utilized in one or more embodiments. FIG. 7 shows the method 700 as including a data-acquisition-and-preparation process 702, an entity-categorization process 704, an entity-delay-risk-and-lead-time modeling process 706, an entity-shortage risk modeling process 708, a module/process-completion risk modeling process 710, a finished-goods-completion risk modeling process 712, an alerts-and-recommendations process 714, a user-interface-capture process 716, and a transactional-system update process 718.

The data-acquisition-and-preparation process 702 involves acquiring and preparing the data from disparate data sources that are used in the method 700 for modeling a production value stream and for making predictions, issuing alerts, making recommendations regarding actions that could be taken, and/or the like, in accordance with various embodiments. The data-acquisition-and-preparation process 702 may involve acquiring data from different nodes in a production value stream, as described herein. The data-acquisition-and-preparation process 702 may further involve preparing the acquired data in terms of data format, removing outlying and/or anomalous values, and/or the like.

The entity-categorization process 704 may involve automatically identifying and classifying raw material, parts, modules, sub-assemblies and/or the like into categories, perhaps by assigning such elements to one of a plurality of categories. This may be similar to the materials-categorization process 402 described above in connection with FIG. 4, and could be based on, as examples, lead time, cost/price, complexity, volume, quality, yield, demand, and/or the like. The entity-categorization process 704 may further include automatically identifying and classifying supplier/distributors into categories, again perhaps by assigning such elements to one of a plurality of categories. This may be similar to the supplier/vendor-categorization process 404 described above in connection with FIG. 4, and could be based on, as examples, lead time, cost/price, complexity, volume, reliability metrics, quality metrics, yield metrics, commitment accuracy, on time delivery performance, capacity, WIP metrics, and/or the like.

The entity-delay-risk-and-lead-time modeling process 706 may involve predicting the risk (e.g., probability) of the occurrence of upstream entity delays, where such upstream entity delays could relate to raw materials, parts, components, modules, subassemblies, sub-process steps, and/or the like. The entity-delay-risk-and-lead-time modeling process 706 may also involve predicting the extent of such delays if they do occur. Moreover, in addition or instead, the entity-delay-risk-and-lead-time modeling process 706 could involve predicting lead times (whether such lead times involve delays or not) that will be needed for various upstream entity to deliver what they are tasked with delivering in the production value stream. The predictions made by the entity-delay-risk-and-lead-time modeling process 706 could pertain in some embodiments to particular suppliers, products, customers, geolocations, and/or the like.

The entity-shortage risk modeling process 708 may involve predicting the risk and extent of one or more upstream entity experiencing an out-of-stock event and/or a shortage event with respect to, e.g., a given raw material. Fulfillment wait times may be predicted. The predictions made by the entity-shortage risk modeling process 708 could be based on inventory positions, distributed demand, entity (e.g., material) inflows, and/or the like.

The module/process-completion risk modeling process 710 may involve predicting risk of and extent of delays in completion of modules, subassemblies, and/or the like. These predictions may be based on factors such as inbound material delays (e.g., delays related to materials listed on bills of materials for given modules), out of stock material risk (e.g. inventory shortage, demand variability), capacity constraints, equipment failures, downtime, sub-optimal settings, operator inefficiency, waste, quality, yield, and/or the like.

The finished-goods-completion risk modeling process 712 may involve predicting throughput (e.g., finished goods produced per unit time). These predictions may be based on factors such as nested entity (material, part, module, etc.) completion delay propagation, critical path/weakest link characteristics, capacity bottlenecks, and/or the like.

The alerts-and-recommendations process 714 may issue prognostic alerts and/or issue value-prioritized action recommendations. The action recommendations may be prioritized in descending order of predicted value-at-risk. In an embodiment, the alerts-and-recommendations process 714 simulates possible sequences of action based on predicted process states. Moreover, in an embodiment, the alerts-and-recommendations process 714 performs action-based and predicted-state-based sequence simulations that minimize an applicable cost function. In at least one embodiment, the applicable cost function encompasses financial and/or operational metrics such as one or more of lost revenue, sales, operating costs, loss of contracts, penalties due non-compliance, delays, and/or the like.

The alerts and action recommendations issued by the alerts-and-recommendations process 714 may be communicated to one or both of a user interface and a transactional system. The user-interface-capture process 716 may capture actions taken via a user interface in response to the alerts and/or action recommendations. The alerts and/or action recommendations presented via a user interface may be customized based on specific roles of users. The transactional-system update process 718 may involve automated actions taken based on the alerts and/or action recommendations. Output from the user-interface-capture process 716 and/or the transactional-system update process 718 may be fed back into the data-acquisition-and-preparation process 702 to further refine and improve the overall functioning of the method 700. In general, operation of the method 700 identifies and takes actions based on causal signals and causal insights related to operation at various nodes of a production value stream.

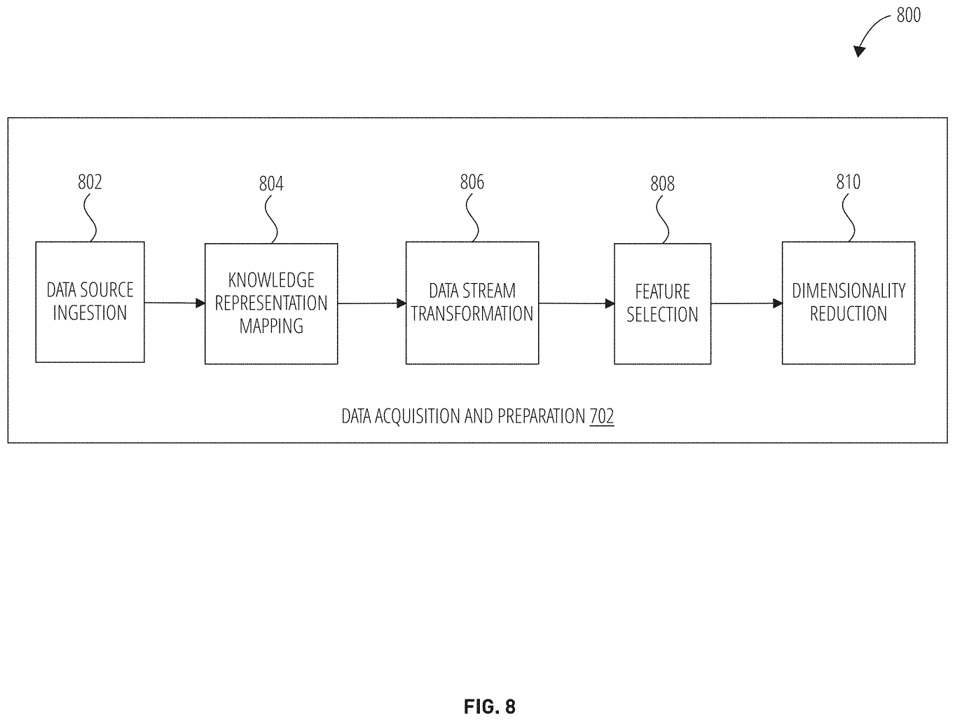

FIG. 8 illustrates a sub-process 800, which depicts an embodiment of the data-acquisition-and-preparation process 702 of the method 700 of FIG. 7. As depicted in FIG. 8, in an embodiment, the data-acquisition-and-preparation process 702 includes a data-source-ingestion process 802, a knowledge-representation mapping process 804, a data-stream-transformation process 806, a feature-selection process 808, and a dimensionality-reduction process 810.

The data-source-ingestion process 802 may involve ingesting data from multiple, disparate data sources that may correspond with various nodes of a production value stream, including upstream nodes and a final-assembly process, as examples. The knowledge-representation mapping process 804 may develop a knowledge-representation map that corresponds to the production value stream. The knowledge-representation mapping process 804 may operate on data received from the data-source-ingestion process 802 using one or more of semantic nets, systems architecture, frames, rules, ontologies, and/or the like. The data-stream-transformation process 806 may operate on the output of the knowledge-representation mapping process 804 and may develop therefrom a set of features, also referred to as attributes, to at least partially characterize the production value stream.

The feature-selection process 808 may reduce the number of inputs for later processing and analysis by identifying a set of the most—or at least some of the relatively more—meaningful inputs (e.g., attributes). In some embodiments, the feature-selection process 808 selects a subset of the attributes identified by the data-stream-transformation process 806, perhaps by scoring or otherwise ranking the attributes and then selecting a subset of the attributes to be used as features in one or more of the plurality of machine-learning models described herein, where it is those one or more machine-learning models that then use the identified features to make predictions.

Feature extraction is a process to reduce the amount of resources required to describe a large set of data. When performing analysis of complex data, one of the major problems is one that stems from the number of variables involved. Analysis with a large number of variables generally requires a large amount of memory and computational power, and it may cause a classification algorithm to overfit to training samples and generalize poorly to new samples. Feature extraction includes constructing combinations of variables to get around these large-data-set problems while still describing the data with sufficient accuracy for the desired purpose.

In some example embodiments, feature extraction starts from an initial set of measured data and builds derived values (features) intended to be informative and non-redundant, facilitating the subsequent learning and generalization steps. Further, feature extraction is related to dimensionality reduction, such as reducing large vectors (sometimes with very sparse data) to smaller vectors capturing the same, or a similar, amount of information.

Determining a subset of the initial features is called feature selection. The selected features are expected to contain the relevant information from the input data, so that the desired task can be performed by using this reduced representation instead of the complete initial data. As an example, deep neural networks (DNNs) utilize a stack of layers, where each layer performs a function. For example, a given layer could be a convolution, a non-linear transform, the calculation of an average, etc. Eventually, a DNN produces outputs. The goal of training the DNN is to find the parameters of all the layers that make them adequate for the desired task.

In some example embodiments, the structure of each layer is predefined. For example, a convolution layer may contain small convolution kernels and their respective convolution parameters, and a summation layer may calculate the sum, or the weighted sum, of two or more values. Training assists in defining the weight coefficients for the summation.

One way to improve the performance of DNNs is to identify newer structures for the feature-extraction layers, and another way is by improving the way the parameters are identified at the different layers for accomplishing a desired task. For a given neural network, there may be millions of parameters to be optimized. Trying to optimize all these parameters from scratch may take hours, days, or even weeks, depending on the amount of computing resources available and the amount of data in the training set.

Following the feature-selection process 808, the dimensionality-reduction process 810 may then streamline (e.g., optimize) the feature set identified by the feature-selection process 808, so as to simplify later processing, perhaps by identifying and removing features that are highly correlated with features already in the feature set. Some example techniques that could be used by the dimensionality-reduction process 810 include Principal Component Analysis (PCA), Linear Discriminant Analysis (LDA), and Generalized Discriminant Analysis (GDA).

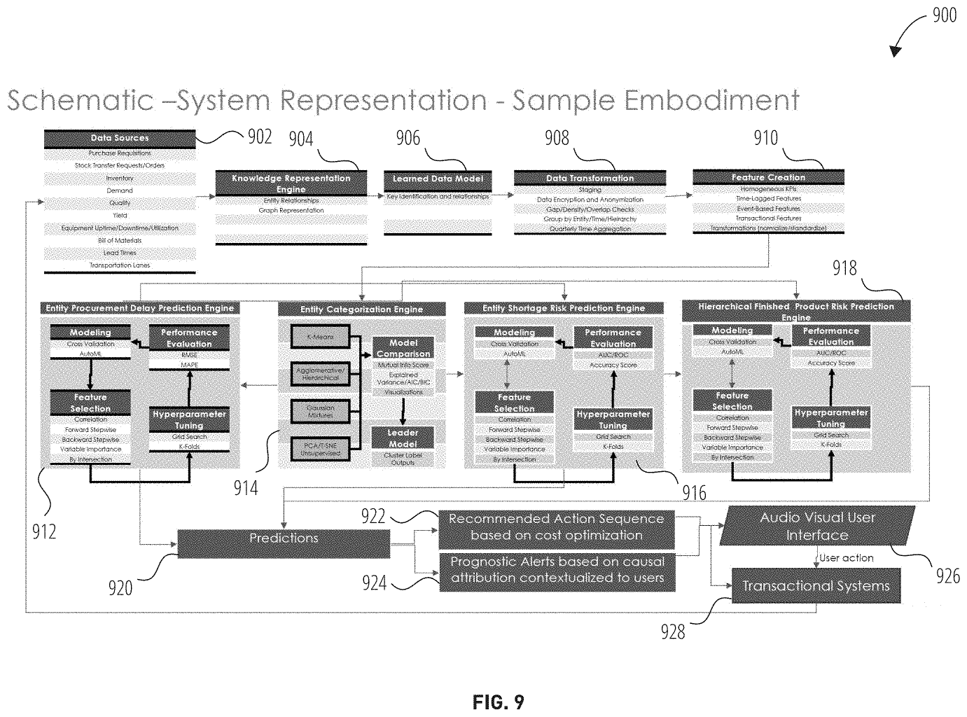

FIG. 9 illustrates a schematic representation of a system 900, in accordance with at least one embodiment. The system 900 includes multiple machine-learning models that may be implemented in one or more of the disclosed embodiments. As depicted in FIG. 9, the system 900 includes data sources 902, a knowledge-representation process 904, a learned data model 906, a data-transformation process 908, a feature-selection process 910, an entity-procurement-delay-prediction process 912, an entity-categorization process 914, an entity-shortage-risk prediction process 916, a hierarchical finished-product-risk-prediction process 918, predictions 920, a recommended action sequence 922, prognostic alerts 924, a user interface 926, and transactional systems 928. Some of these aspects are similar to aspects described above, and thus are not described in FIG. 9 in as great of detail.

The data sources 902 include purchase requisitions; stock transfer requests and/or orders; inventory; demand; quality; yield; equipment uptime, downtime, and/or utilization; bill of materials; lead times; and transportation lanes. The knowledge-representation process 904 identifies entity relationships and produces graph representations of such. The learned data model 906 reflects key identification and relationships. The data-transformation process 908 conducts staging; data encryption and anonymization; gap, density, and/or overlap checks; grouping by entity, time, and/or hierarchy; and quarterly time aggregation. The feature-selection process 910 identifies homogeneous KPIs, time-lagged features, event-based features, transactional features, and transformations (normalized and/or standardized). The identified features are fed into the entity-categorization process 914.

The entity-categorization process 914 uses techniques such as k-means, agglomerative and/or hierarchical techniques. Gaussian mixtures, and PCA/t-Distributed Stochastic Neighbor Embedding (T-SNE) unsupervised learning to produce a model comparison that includes a mutual information score, an explained variance/Akaike's Information Criteria (AIC)/Bayesian Information Criteria (BIC), and visualizations. This model comparison then results in identification of a leader model having cluster label outputs. The results of the entity-categorization process 914 feed into both the entity-procurement-delay-prediction process 912 and the entity-shortage-risk prediction process 916.

As is shown in FIG. 9, the entity-procurement-delay-prediction process 912, the entity-shortage-risk prediction process 916, and the hierarchical finished-product-risk-prediction process 918 each include a respective modeling component, feature-selection component, performance-evaluation component, and hyperparameter-tuning component. In each case, the modeling component involves cross validation and automated machine learning (AutoML). Each feature-selection component involves feature selection using techniques such as correlation, forward stepwise, backward stepwise, variable importance, and by intersection. Each hyperparameter-tuning component involves techniques such as grid search and k-folds. Each performance-evaluation component involves techniques such as root-mean-square error (RMSE) and mean absolute percentage error (MAPE).

The entity-procurement-delay-prediction process 912 takes as its input the results of the entity-categorization process 914, and outputs its predictions to both the entity-shortage-risk prediction process 916 and the predictions 920. The entity-shortage-risk prediction process 916 takes as inputs both the results of the entity-categorization process 914 and the predictions of the entity-procurement-delay-prediction process 912, and outputs its predictions to both the hierarchical finished-product-risk-prediction process 918 and the predictions 920. The hierarchical finished-product-risk-prediction process 918 takes as its inputs both the predictions of the entity-procurement-delay-prediction process 912 and the predictions of the entity-shortage-risk prediction process 916, and outputs its predictions to the predictions 920.

The predictions 920 thus represent the collective predictions of the entity-procurement-delay-prediction process 912, the entity-shortage-risk prediction process 916, and the hierarchical finished-product-risk-prediction process 918. The predictions 920 then lead to both the recommended action sequence 922 and the prognostic alerts 924, both of which are output to both the user interface 926 and the transactional systems 928. The output of the user interface 926 is fed into the transactional systems 928, and the output of the transactional systems 928 is fed back into being one of the data sources 902.

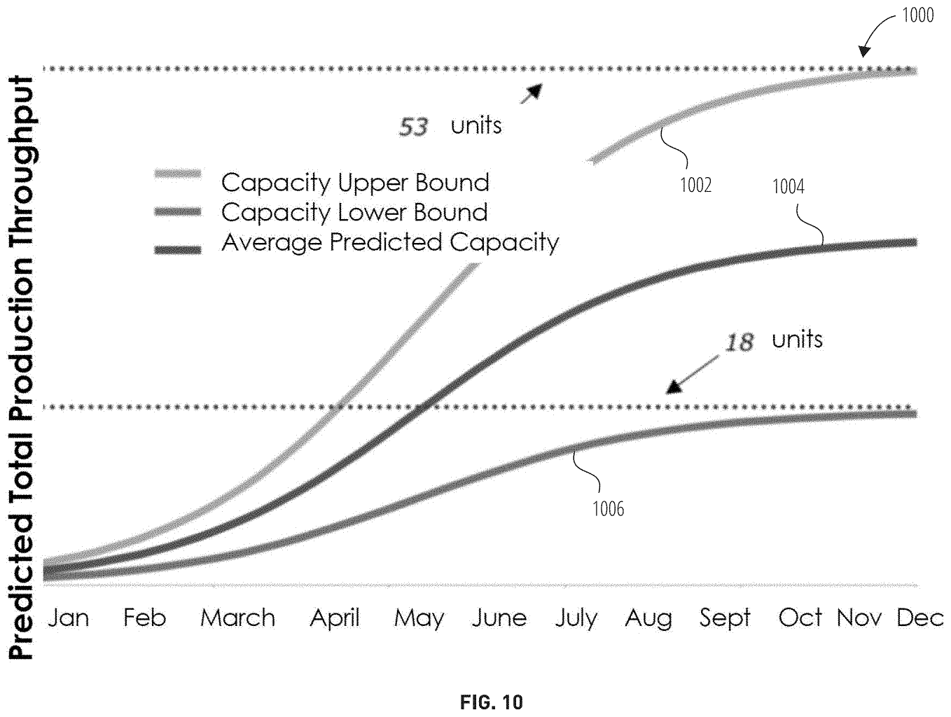

FIG. 10 illustrates an example graph 1000 of predicted throughput of a production value stream, in accordance with one embodiment. The x-axis shows months of an example year. The y-axis shows predicted total throughput in terms of arbitrary units. A first curve 1002 corresponds to a capacity upper bound of the production value stream, and approaches a horizontal asymptote at a value of 53 units. A second curve 1006 corresponds to a capacity lower bound of the production value stream, and approaches a horizontal asymptote at a value of 18 units. A third curve 1004 corresponds to an average predicted capacity of the production value stream. The graph 1000 could be presented via a user interface in accordance with an embodiment.

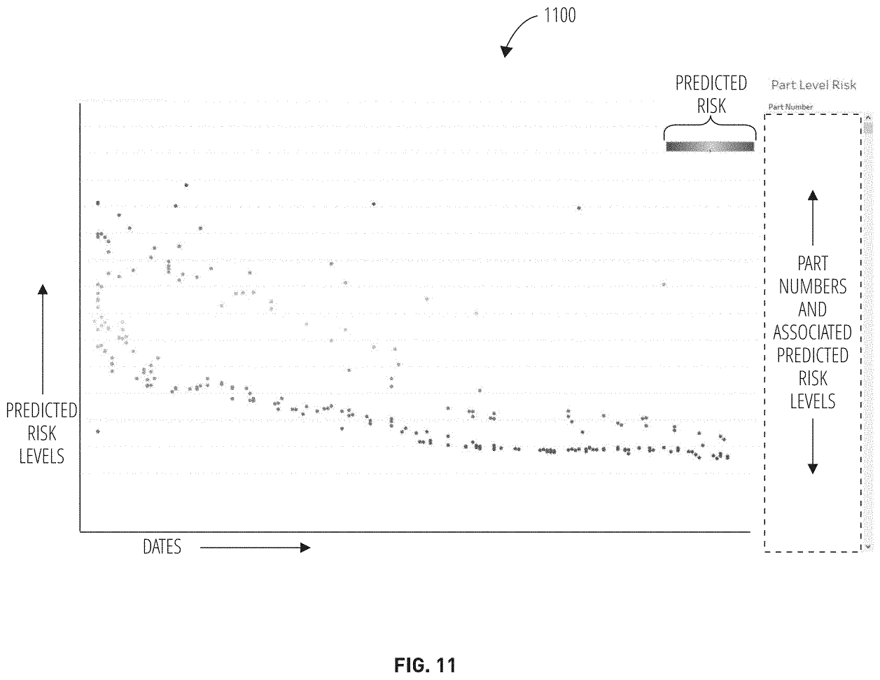

FIG. 11 illustrates an example graph 1100 of production risk based on a planned schedule, in accordance with at least one embodiment. The x-axis corresponds to calendar dates that represent planned production start dates. The y-axis corresponds to predicted risk levels on a per-part-number basis, where that predicted risk could be normalized to values between 0 and 1. Each point on the scatter plot represents a given predicted risk for a given part for a given planned production start date. The predicted risk values could represent probabilities of a risk of a certain amount of delay, or a combined index that reflects both probability of delay and extent of delay if it occurs, among other possible examples. The graph 1100 could be presented via a user interface in accordance with an embodiment. The dashed-line rectangle on the right side of the graph could include rows of part numbers and associated predicted risk levels. The color spectrum from blue on the left to orange in the middle to red on the right corresponds with the respective y values of the various scatter-plot points.

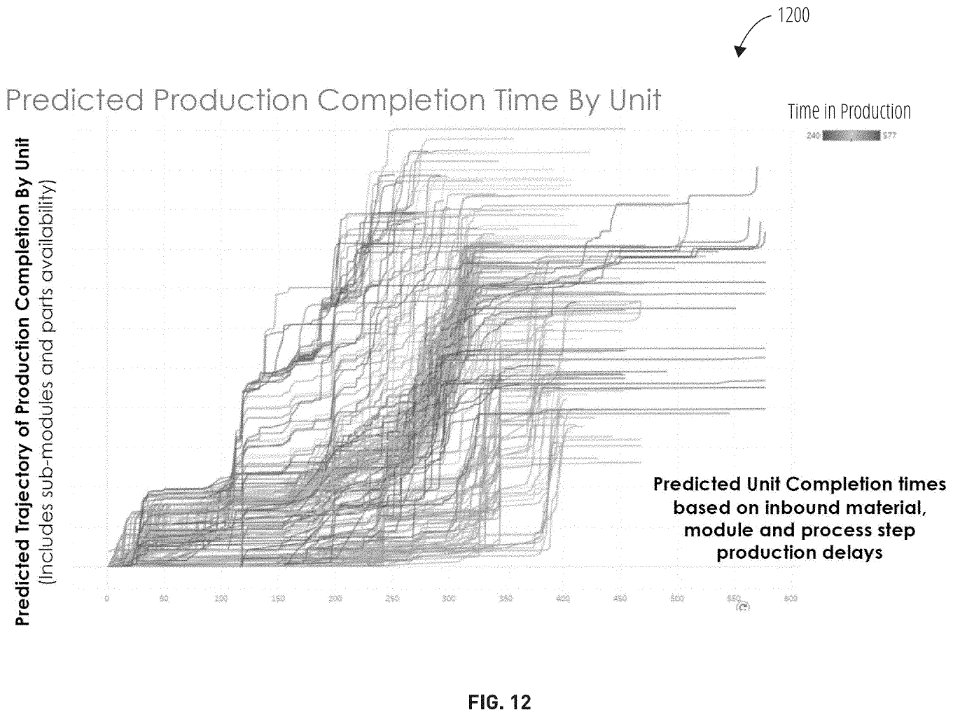

FIG. 12 illustrates an example graph of predicted production completion time by unit, in accordance with at least one embodiment. Each unit could correspond with a different product. The x-axis shows number of units of time (e.g., days), and relates to predicted unit (i.e., product) completion times based on inbound material, module, and process step (e.g., sub-process) production delays. The y-axis is not dimensioned according to any particular units, but the vertical step-wise nature of the graph is useful in visualizing individual delays. Each different stage transition during production of a given product displays as a vertical step, and the horizontal length of each segment shows the duration of the particular stage (including delay) in terms of units of time. The graph 1200 could be presented via a user interface in accordance with an embodiment. The color spectrum from green on the left to yellow in the middle to red on the right corresponds to example units of time.

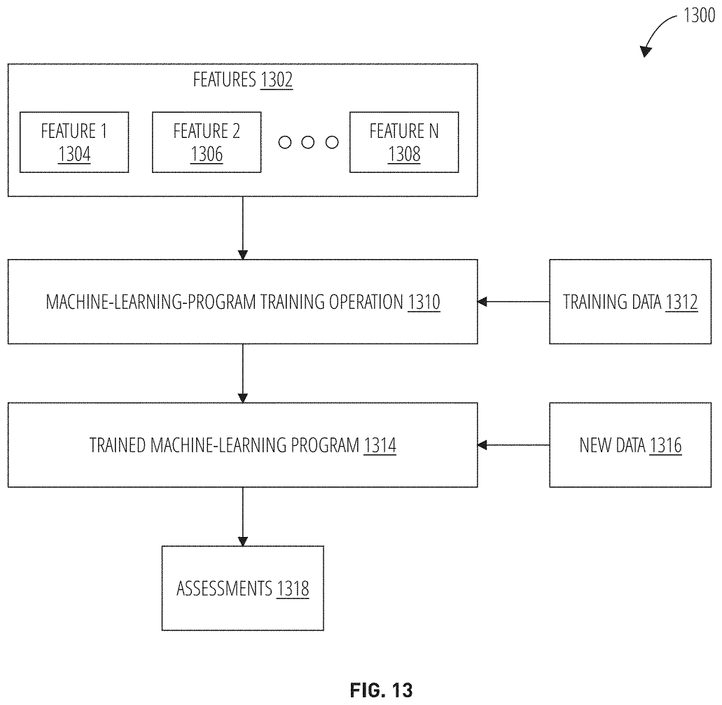

FIG. 13 illustrates an example machine-learning framework 1300, in accordance with at least one embodiment. The machine-learning framework 1300 includes features 1302, training data 1312, a machine-learning-program training operation 1310, a trained machine-learning program 1314, new data 1316, and an assessments 1318. As a general matter, FIG. 13 illustrates the training and use of a machine-learning program, according to some example embodiments. In some example embodiments, machine-learning programs (MLPs), also referred to as machine-learning algorithms or tools, are utilized to perform operations associated with making upstream-entity predictions and end-production-process predictions, as examples, in connection with a production value stream.

Machine learning is a field of study that gives computers the ability to learn without being explicitly programmed. Machine learning explores the study and construction of algorithms, also referred to herein as tools, that may learn from existing data and make predictions about new data. Such machine-learning tools operate by building a model from example training data 1312 in order to make data-driven predictions or decisions expressed as outputs or assessments 1318. Although example embodiments are presented with respect to a few machine-learning tools, the principles presented herein may be applied to other machine-learning tools. In some example embodiments, different machine-learning tools may be used. As examples, logistic regression (LR), Naïve-Bayes, random forest (RF), neural networks (NN), matrix factorization, and support vector machines (SVM) tools may be used.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number). In some embodiments, example machine-learning algorithms provide a risk prediction (e.g., a prediction related to probability and extent of upstream and/or end-production delay). The machine-learning algorithms utilize the training data 1312 to find correlations among identified features 1302 that affect an outcome.

The machine-learning algorithms utilize features 1302 for analyzing the data to generate assessments 1318. Each of the features 1302 is an individual measurable property of a phenomenon being observed. The concept of a feature is related to that of an explanatory variable used in statistical techniques such as linear regression. Choosing informative, discriminating, and independent features is important for effective operation of the MLP in pattern recognition, classification, and regression. Features may be of different types, such as numeric features, strings, and graphs. In one example embodiment, the features 1302 may be of different types, represented generally by a feature 1 1304, a feature 2 1306, and a feature N 1308, indicating an arbitrary number N of features.

The machine-learning algorithms utilize the training data 1312 to find correlations among the identified features 1302 that affect the outcome or assessments 1318. In some example embodiments, the training data 1312 includes labeled data, which is known data for one or more identified features 1302 and one or more outcomes, such as predicted upstream and/or end-production delays, predicted throughput of a production value stream, and/or the like.

With the training data 1312 and the identified features 1302, the machine-learning tool is trained at machine-learning-program training operation 1310. The machine-learning tool appraises the value of the features 1302 as they correlate to the training data 1312. The result of the training is the trained machine-learning program 1314.

When the trained machine-learning program 1314 is used to perform an assessment, new data 1316 is provided as an input to the trained machine-learning program 1314, and the trained machine-learning program 1314 generates the assessments 1318 as output. For example, based on a input set of operational metrics for a given node in a production value stream, the trained machine-learning program 1314 outputs a predicted delay for that node.

Machine-learning techniques train models to accurately make predictions on data fed into the models (e.g., what was said by a user in a given utterance; whether a noun is a person, place, or thing; what the weather will be like tomorrow). During a learning phase, the models are developed against a training dataset of inputs to optimize the models to correctly predict the output for a given input. Generally, the learning phase may be supervised, semi-supervised, or unsupervised; indicating a decreasing level to which the “correct” outputs are provided in correspondence to the training inputs. In a supervised learning phase, all of the outputs are provided to the model and the model is directed to develop a general rule or algorithm that maps the input to the output. In contrast, in an unsupervised learning phase, the desired output is not provided for the inputs so that the model may develop its own rules to discover relationships within the training dataset. In a semi-supervised learning phase, an incompletely labeled training set is provided, with some of the outputs known and some unknown for the training dataset.

Models may be run against a training dataset for several epochs (e.g., iterations), in which the training dataset is repeatedly fed into the model to refine its results. For example, in a supervised learning phase, a model is developed to predict the output for a given set of inputs, and is evaluated over several epochs to more reliably provide the output that is specified as corresponding to the given input for the greatest number of inputs for the training dataset. In another example, for an unsupervised learning phase, a model is developed to cluster the dataset into n groups, and is evaluated over several epochs as to how consistently it places a given input into a given group and how reliably it produces the n desired clusters across each epoch.

Once an epoch is run, the models are evaluated and the values of their variables are adjusted to attempt to better refine the model in an iterative fashion. In various aspects, the evaluations are biased against false negatives, biased against false positives, or evenly biased with respect to the overall accuracy of the model. The values may be adjusted in several ways depending on the machine-learning technique being used. For example, in a genetic or evolutionary algorithm, the values for the models that are most successful in predicting the desired outputs are used to develop values for models to use during the subsequent epoch, which may include random variation/mutation to provide additional data points. One of ordinary skill in the art will be familiar with several other machine-learning algorithms that may be applied with the present disclosure, including linear regression, random forests, decision-tree learning, neural networks, deep neural networks, etc.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the nth epoch, the learning phase may end early and the produced model maybe used as satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that is has not been trained on. In a second example, a false positive rate or false negative rate may be used to evaluate the models after finalization. In a third example, a delineation between data clusterings is used to select a model that produces the clearest bounds for its clusters of data.

In some example embodiments, a model (e.g., a student model) includes, or is trained by, a neural network (e.g., deep learning, deep convolutional, or recurrent neural network), which comprises a series of “neurons,” such as Long Short Term Memory (LSTM) nodes, arranged into a network. A neuron is an architectural element used in data processing and artificial intelligence, particularly machine learning, that includes memory that may determine when to “remember” and when to “forget” values held in that memory based on the weights of inputs provided to the given neuron. Each of the neurons used herein are configured to accept a predefined number of inputs from other neurons in the network to provide relational and sub-relational outputs for the content of the frames being analyzed. Individual neurons may be chained together and/or organized into tree structures in various configurations of neural networks to provide interactions and relationship learning modeling for how each of the frames in an utterance are related to one another.

For example, an LSTM serving as a neuron includes several gates to handle input vectors, a memory cell, and an output vector. The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation. One of skill in the art will appreciate that neurons and neural networks may be constructed programmatically (e.g., via software instructions) or via specialized hardware linking each neuron to form the neural network.

Neural networks utilize features for analyzing the data to generate assessments (e.g., recognize units of speech). A feature is an individual measurable property of a phenomenon being observed. The concept of feature is related to that of an explanatory variable used in statistical techniques such as linear regression. Further, deep features represent the output of nodes in hidden layers of the deep neural network.

A neural network, sometimes referred to as an artificial neural network, is a computing system based on consideration of biological neural networks of animal brains. Such systems progressively improve performance, which is referred to as learning, to perform tasks, typically without task-specific programming. For example, in image recognition, a neural network may be taught to identify images that contain an object by analyzing example images that have been tagged with a name for the object and, having learned the object and name, may use the analytic results to identify the object in untagged images. A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input, which assigns significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight update. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value which roughly represents its contribution to the original output. Backpropagation can use these error values to calculate the gradient of the cost function with respect to the weights in the neural network. The calculated gradient is fed to the selected optimization method to update the weights to attempt to minimize the cost function.

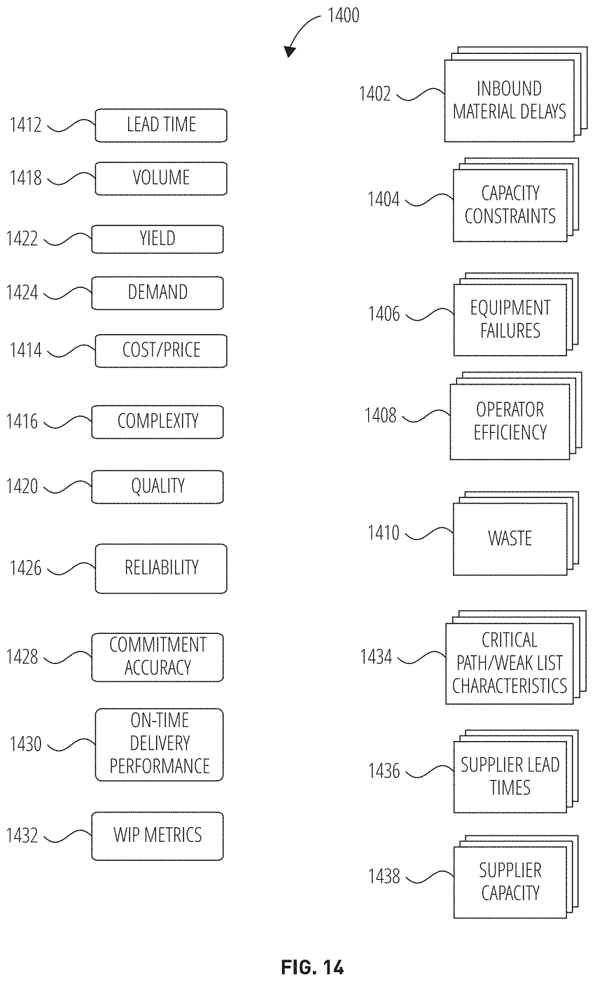

FIG. 14 illustrates examples of data items that can be used as features for training one or more machine-learning models, in accordance with at least one embodiment. In various different embodiments, the data items that are shown by way of example in the diagram 1400 of FIG. 14 could be received or ingested by one or more machine-learning models. Some of the data items pertain to specific orders and products (e.g., lead time 1412, volume 1418, yield 1422, demand 1424, and cost/price 1414). Other example data items shown in FIG. 14 pertain to a production value stream (e.g., inbound material delays 1402, capacity constraints 1404, equipment failures 1406, operator efficiency 1408, waste 1410, and critical path/weak list characteristics 1434). Others of the data items pertain to various production nodes (e.g., supplier lead times 1436, supplier capacity 1438, on-time delivery performance 1430, and WIP metrics 1432). Additional data items include complexity 1416, quality 1420, reliability 1426, and commitment accuracy 1428. All of these data items are provided by way of example and not limitation. Any other data items mentioned herein could also or instead be used as features for training one or more machine-learning models. Various embodiments combine data across the production value stream, and include both historic KPIs, as well as forward-looking predictions and targets for key performance metrics.

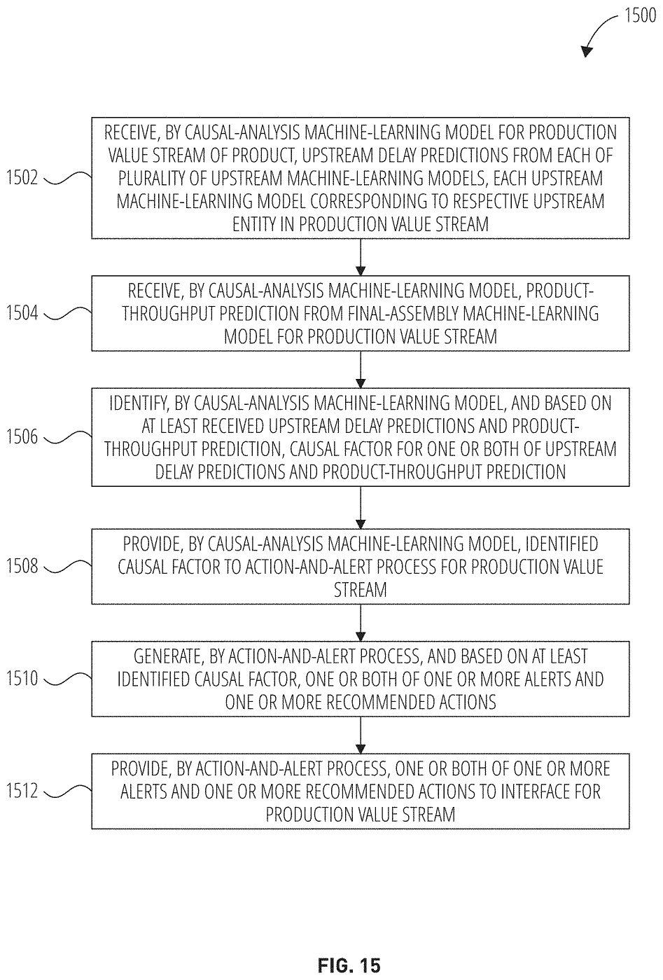

FIG. 15 illustrates an example method 1500 for identifying and addressing production risks (e.g., production-delay risks), in accordance with at least one embodiment. The method 1500 is described by way of example as being carried out by the causal-analysis machine-learning model 124 and the action-and-alert process 126 of FIG. 1.

At operation 1502, the causal-analysis machine-learning model 124 receives upstream delay predictions from each of a plurality of upstream machine-learning models (e.g., the first-component machine-learning model 116, the second-component machine-learning model 118, and the third-component machine-learning model 120), each upstream machine-learning model corresponding to a respective upstream entity in the production value stream.

At operation 1504, the causal-analysis machine-learning model 124 receives product-throughput prediction from a final-assembly machine-learning model for the production value stream (e.g., the final-assembly machine-learning model 122).

At operation 1506, the causal-analysis machine-learning model 124 identifies, based on at least the received upstream delay predictions and the product-throughput prediction, causal factor for one or both of the upstream delay predictions and the product-throughput prediction.

At operation 1508, the causal-analysis machine-learning model 124 provides the identified causal factor to an action-and-alert process for the production value stream (e.g., the action-and-alert process 126).

At operation 1510, the action-and-alert process 126 generates, based on at least the identified causal factor, one or both of one or more alerts (e.g., the alerts 156) and one or more recommended actions (e.g., the recommended actions 168).

At operation 1512, the action-and-alert process 126 provides the one or both of one or more alerts and one or more recommended actions to an interface for the production value stream (e.g., the implementation interface 160).

In at least one embodiment, the respective upstream machine-learning models receive operational metric corresponding to the respective upstream entity; generate, based on at least the received operational metric corresponding to the respective upstream entity, upstream delay predictions corresponding to the respective upstream entity; and provide the upstream delay predictions to both the final-assembly machine-learning model and the causal-analysis machine-learning model.

In at least one embodiment, the final-assembly machine-learning model receives operational metric corresponding to the final-assembly process; receives the upstream delay predictions from the respective upstream machine-learning models; generates, based on at least the received operational metric corresponding to the final-assembly process and the upstream delay predictions from the respective upstream machine-learning models, product-throughput prediction for the product; and provides the product-throughput prediction to the causal-analysis machine-learning model.

In at least one embodiment, the interface receives the one or both of one or more alerts and one or more recommended actions from the action-and-alert process; and obtains and processes response to the one or both of one or more alerts and one or more recommended actions. In at least one further embodiment, the interface also provides data reflective of the response to one or more of one or more of the upstream entity, the final-assembly process, one or more of the upstream machine-learning models, and the final-assembly machine-learning model.

In at least one embodiment, the one or more upstream entity include one or more of a part, a component, a module, a sub-assembly, a factory, a geolocation, and a sub-process. In at least one embodiment, the one or more upstream entity collectively represent multiple dependent layers of the production value stream. In at least one embodiment, the operational metric corresponding to the respective upstream entity comprise one or more of inventory level, lead time, cost, price, complexity, volume, quality, yield, demand, and reliability. In at least one embodiment, the operational metric corresponding to the respective upstream entity comprise historical data reflective of the operational metric corresponding to the respective upstream entity over a time period.

In at least one embodiment, the interface includes a user interface, and the response include at least one response received via the user interface. In at least one embodiment, the interface includes an automated interface; and the response include at least one response received via the automated interface.

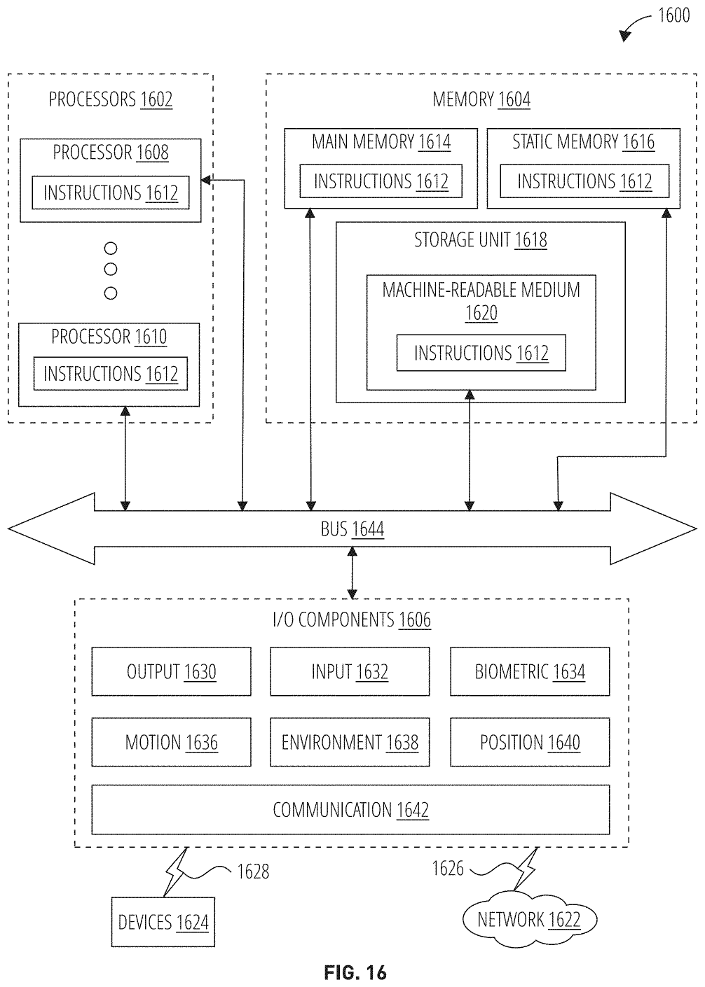

FIG. 16 is a diagrammatic representation of a machine 1600 within which instructions 1612 (e.g., software, a program, an application, an applet, an app, or other executable code) for causing the machine 1600 to perform any one or more of the methodologies discussed herein may be executed. For example, the instructions 1612 may cause the machine 1600 to execute any one or more of the methods described herein. The instructions 1612 transform the general, non-programmed machine 1600 into a particular machine 1600 programmed to carry out the described and illustrated functions in the manner described. The machine 1600 may operate as a standalone device or may be coupled (e.g., networked) to other machines. In a networked deployment, the machine 1600 may operate in the capacity of a server machine or a client machine in a server-client network environment, or as a peer machine in a peer-to-peer (or distributed) network environment. The machine 1600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1612, sequentially or otherwise, that specify actions to be taken by the machine 1600. Further, while only a single machine 1600 is illustrated, the term “machine” shall also be taken to include a collection of machines that individually or jointly execute the instructions 1612 to perform any one or more of the methodologies discussed herein.

The machine 1600 may include processors 1602, memory 1604, and I/O components 1606, which may be configured to communicate with each other via a bus 1644. In an example embodiment, the processors 1602 (e.g., a central processing unit (CPU), a Reduced Instruction Set Computing (RISC) processor, a Complex Instruction Set Computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1608 and a processor 1610 that execute the instructions 1612. The term “processor” is intended to include multi-core processors that may include two or more independent processors (sometimes referred to as “cores”) that may execute instructions contemporaneously. Although FIG. 16 shows multiple processors 1602, the machine 1600 may include a single processor with a single core, a single processor with multiple cores (e.g., a multi-core processor), multiple processors with a single core, multiple processors with multiples cores, or any combination thereof.

The memory 1604 includes a main memory 1614, a static memory 1616, and a storage unit 1618, all accessible to the processors 1602 via the bus 1644. The memory 1604, the static memory 1616, and the storage unit 1618 store the instructions 1612 embodying any one or more of the methodologies or functions described herein. The instructions 1612 may also reside, completely or partially, within the main memory 1614, within the static memory 1616, within machine-readable medium 1620 within the storage unit 1618, within at least one of the processors 1602 (e.g., within the processor's cache memory), or any suitable combination thereof, during execution thereof by the machine 1600.

The I/O components 1606 may include a wide variety of components to receive input, provide output, produce output, transmit information, exchange information, capture measurements, and so on. The specific I/O components 1606 that are included in a particular machine will depend on the type of machine. For example, portable machines such as mobile phones may include a touch input device or other such input mechanisms, while a headless server machine will likely not include such a touch input device. It will be appreciated that the I/O components 1606 may include many other components that are not shown in FIG. 16. In various example embodiments, the I/O components 1606 may include output components 1630 and input components 1632. The output components 1630 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1632 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1606 may include biometric components 1634, motion components 1636, environmental components 1638, and/or position components 1640, among a wide array of other components. For example, the biometric components 1634 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1636 may include acceleration sensor components (e.g., accelerometer), gravitation sensor components, rotation sensor components (e.g., gyroscope), and so forth. The environmental components 1638 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas-detection sensors to detection concentrations of hazardous gases for safety or to measure pollutants in the atmosphere), or other components that may provide indications, measurements, or signals corresponding to a surrounding physical environment. The position components 1640 may include location-sensor components (e.g., a global positioning system (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1606 further include communication components 1642 operable to couple the machine 1600 to a network 1622 or devices 1624 via a coupling 1626 and a coupling 1628, respectively. For example, the communication components 1642 may include a network interface component or another suitable device to interface with the network 1622. In further examples, the communication components 1642 may include wired-communication components, wireless-communication components, cellular-communication components, Near Field Communication (NFC) components, Bluetooth components (e.g., Bluetooth Low Energy). Wi-Fi components, and/or other communication components to provide communication via other modalities. The devices 1624 may be another machine or any of a wide variety of peripheral devices (e.g., a peripheral device coupled via a universal serial bus (USB) connection).

Moreover, the communication components 1642 may detect identifiers or include components operable to detect identifiers. For example, the communication components 1642 may include radio frequency identification (RFID) tag reader components, NFC smart tag detection components, optical reader components (e.g., an optical sensor to detect one-dimensional bar codes such as Universal product Code (UPC) bar codes, multi-dimensional bar codes such as Quick Response (QR) codes, Aztec codes, Data Matrix, Dataglyph, MaxiCode. PDF417. Ultra Code. UCC RSS-2D bar codes, and/or other optical codes), and/or acoustic detection components (e.g., microphones to identify tagged audio signals). In addition, a variety of information may be derived via the communication components 1642, such as location via Internet Protocol (IP) geolocation, location via Wi-Fi signal triangulation, location via detecting an NFC beacon signal that may indicate a particular location, and so forth.

The various memories (e.g., memory 1604, main memory 1614, static memory 1616, and/or memory of the processors 1602) and/or storage unit 1618 may store one or more sets of instructions and data structures (e.g., software) embodying or used by any one or more of the methodologies or functions described herein. These instructions (e.g., the instructions 1612), when executed by processors 1602, cause various operations to implement the disclosed embodiments.

The instructions 1612 may be transmitted or received over the network 1622, using a transmission medium, via a network interface device (e.g., a network interface component included in the communication components 1642) and using any one of a number of well-known transfer protocols (e.g., hypertext transfer protocol (HTTP)). Similarly, the instructions 1612 may be transmitted or received using a transmission medium via the coupling 1628 (e.g., a peer-to-peer coupling) to the devices 1624.

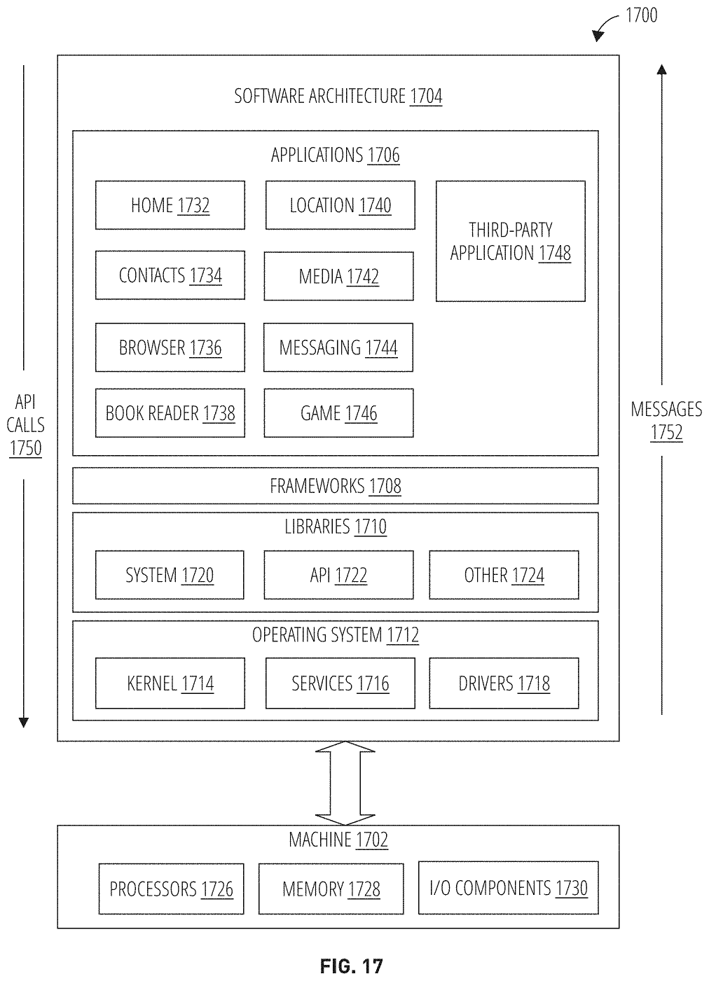

FIG. 17 is a block diagram 1700 illustrating a software architecture 1704, which can be installed on any one or more of the devices described herein. The software architecture 1704 is supported by hardware such as a machine 1702 that includes processors 1726, memory 1728, and I/O components 1730. In this example, the software architecture 1704 can be conceptualized as a stack of layers, where each layer provides a particular functionality. The software architecture 1704 includes layers such an operating system 1712, libraries 1710, frameworks 1708, and applications 1706. Operationally, the applications 1706 invoke API calls 1750 through the software stack and receive messages 1752 in response to the API calls 1750.

The operating system 1712 manages hardware resources and provides common services. The operating system 1712 includes, for example, a kernel 1714, services 1716, and drivers 1718. The kernel 1714 acts as an abstraction layer between the hardware and the other software layers. For example, the kernel 1714 provides memory management, processor management (e.g., scheduling), component management, networking, and security settings, among other functionality. The services 1716 can provide other common services for the other software layers. The drivers 1718 are responsible for controlling or interfacing with the underlying hardware. For instance, the drivers 1718 can include display drivers, camera drivers. Bluetooth or Bluetooth Low Energy drivers, flash memory drivers, serial communication drivers (e.g., USB drivers), Wi-Fi drivers, audio drivers, power management drivers, and so forth.

The libraries 1710 provide a low-level common infrastructure used by the applications 1706. The libraries 1710 can include system libraries 1720 (e.g., C standard library) that provide functions such as memory-allocation functions, string-manipulation functions, mathematic functions, and the like. In addition, the libraries 1710 can include API libraries 1722 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web-browsing functionality), and the like. The libraries 1710 can also include a wide variety of other libraries 1724 to provide many other APIs to the applications 1706.

The frameworks 1708 provide a high-level common infrastructure that is used by the applications 1706. For example, the frameworks 1708 provide various graphical user interface (GUI) functions, high-level resource management, and high-level location services. The frameworks 1708 can provide a broad spectrum of other APIs that can be used by the applications 1706, some of which may be specific to a particular operating system or platform.

In an example embodiment, the applications 1706 may include a home application 1732, a contacts application 1734, a browser application 1736, a book-reader application 1738, a location application 1740, a media application 1742, a messaging application 1744, a game application 1746, and a broad assortment of other applications such as a third-party application 1748. The applications 1706 are programs that execute functions defined in the programs. Various programming languages can be employed to create one or more of the applications 1706, structured in a variety of manners, such as object-oriented programming languages (e.g., Objective-C. Java, or C++) or procedural programming languages (e.g., C or assembly language). In a specific example, the third-party application #SOF40 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1748 can invoke the API calls 1750 provided by the operating system 1712 to facilitate functionality described herein.

To promote an understanding of the principles of the present disclosure, various embodiments are illustrated in the drawings. The embodiments disclosed herein are not intended to be exhaustive or to limit the present disclosure to the precise forms that are disclosed in the above detailed description. Rather, the described embodiments have been selected so that others skilled in the art may utilize their teachings. Accordingly, no limitation of the scope of the present disclosure is thereby intended.

In any instances in this disclosure, including in the claims, in which numeric modifiers such as first, second, and third are used in reference to components, data (e.g., values, identifiers, parameters, and/or the like), and/or any other elements, such use of such modifiers is not intended to denote or dictate any specific or required order of the elements that are referenced in this manner. Rather, any such use of such modifiers is intended to assist the reader in distinguishing elements from one another, and should not be interpreted as insisting upon any particular order or carrying any other significance, unless such an order or other significance is clearly and affirmatively explained herein.

Moreover, consistent with the fact that the entities and arrangements that are described herein, including the entities and arrangements that are depicted in and described in connection with the drawings, are presented as examples and not by way of limitation, any and all statements or other indications as to what a particular drawing “depicts,” what a particular element or entity in a particular drawing or otherwise mentioned in this disclosure “is” or “has,” and any and all similar statements that are not explicitly self-qualifying by way of a clause such as “In at least one embodiment,” and that could therefore be read in isolation and out of context as absolute and thus as a limitation on all embodiments, can only properly be read as being constructively qualified by such a clause. It is for reasons akin to brevity and clarity of presentation that this implied qualifying clause is not repeated ad nauseum in this disclosure.

What is claimed is:

1. A system comprising:
an upstream machine-learning model corresponding to each of one or more upstream entity in a production value stream of a product;
a final-assembly machine-learning model corresponding to a final-assembly process in the production value stream of the product;
a causal-analysis machine-learning model for the production value stream of the product;
an action-and-alert process for the production value stream of the product; and
an implementation interface for the production value stream of the product, wherein:
each upstream machine-learning model is configured to:
receive operational metric corresponding to the respective upstream entity;
generate, based on at least the received operational metric corresponding to the respective upstream entity, upstream delay predictions corresponding to the respective upstream entity; and
provide the upstream delay predictions to both the final-assembly machine-learning model and the causal-analysis machine-learning model;
the final-assembly machine-learning model is configured to:
receive operational metric corresponding to the final-assembly process;
receive the upstream delay predictions from the respective upstream machine-learning models;
generate, based on at least the received operational metric corresponding to the final-assembly process and the upstream delay predictions from the respective upstream machine-learning models, product-throughput prediction for the product; and
provide the product-throughput prediction to the causal-analysis machine-learning model;
the causal-analysis machine-learning model is configured to:
receive the upstream delay predictions from the respective upstream machine-learning models;
receive the product-throughput prediction from the final-assembly machine-learning model;
identify, based on at least the received upstream delay predictions from the respective upstream machine-learning models and the product-throughput prediction from the final-assembly machine-learning model, causal factor for one or both of the upstream delay predictions and the product-throughput prediction; and
provide the identified causal factor to the action-and-alert process;
the action-and-alert process is configured to:
receive the identified causal factor from the causal-analysis machine-learning model;
generate, based on at least the identified causal factor, one or both of one or more alerts and one or more recommended actions; and
providing the one or both of one or more alerts and one or more recommended actions to the implementation interface;
the implementation interface is configured to:
receive the one or both of one or more alerts and one or more recommended actions from the action-and-alert process;
obtain and process response to the one or both of one or more alerts and one or more recommended actions; and
provide data reflective of the response to one or more of one or more of the upstream entity, the final-assembly process, one or more of the upstream machine-learning models, and the final-assembly machine-learning model.

2. The system of claim 1, wherein the one or more upstream entity comprise one or more of a part, a component, a module, a sub-assembly, a factory, a geolocation, and a sub-process.

3. The system of claim 1, wherein the one or more upstream entity collectively represent multiple dependent layers of the production value stream.

4. The system of claim 1, wherein the operational metric corresponding to the respective upstream entity comprise one or more of inventory level, lead time, cost, price, complexity, volume, quality, yield, demand, and reliability.

5. The system of claim 1, wherein the operational metric corresponding to the respective upstream entity comprise historical data reflective of the operational metric corresponding to the respective upstream entity over a time period.

6. The system of claim 1, wherein:
the implementation interface comprises a user interface; and
the response comprise at least one response received via the user interface.

7. The system of claim 1, wherein:
the implementation interface comprises an automated interface; and
the response comprise at least one response received via the automated interface.

8. A method comprising:
receiving, by a causal-analysis machine-learning model for a production value stream of a product, upstream delay predictions from each of a plurality of upstream machine-learning models, each upstream machine-learning model corresponding to a respective upstream entity in the production value stream;
receiving, by the causal-analysis machine-learning model, product-throughput prediction from a final-assembly machine-learning model for the production value stream;
identifying, by the causal-analysis machine-learning model, and based on at least the received upstream delay predictions and the product-throughput prediction, causal factor for one or both of the upstream delay predictions and the product-throughput prediction;
providing, by the causal-analysis machine-learning model, the identified causal factor to an action-and-alert process for the production value stream;
generating, by the action-and-alert process, and based on at least the identified causal factor, one or both of one or more alerts and one or more recommended actions; and
providing, by the action-and-alert process, the one or both of one or more alerts and one or more recommended actions to an implementation interface for the production value stream.

9. The method of claim 8, further comprising the respective upstream machine-learning models:
receiving operational metric corresponding to the respective upstream entity;
generating, based on at least the received operational metric corresponding to the respective upstream entity, upstream delay predictions corresponding to the respective upstream entity; and
providing the upstream delay predictions to both the final-assembly machine-learning model and the causal-analysis machine-learning model.

10. The method of claim 8, further comprising the final-assembly machine-learning model:
receiving operational metric corresponding to the final-assembly process;
receiving the upstream delay predictions from the respective upstream machine-learning models;
generating, based on at least the received operational metric corresponding to the final-assembly process and the upstream delay predictions from the respective upstream machine-learning models, product-throughput prediction for the product; and
providing the product-throughput prediction to the causal-analysis machine-learning model.

11. The method of claim 8, further comprising the implementation interface:
receiving the one or both of one or more alerts and one or more recommended actions from the action-and-alert process; and
obtaining and processing response to the one or both of one or more alerts and one or more recommended actions.

12. The method of claim 11, further comprising the implementation interface:
providing data reflective of the response to one or more of one or more of the upstream entity, the final-assembly process, one or more of the upstream machine-learning models, and the final-assembly machine-learning model.

13. The method of claim 8, wherein the one or more upstream entity comprise one or more of a part, a component, a module, a sub-assembly, a factory, a geolocation, and a sub-process.

14. The method of claim 8, wherein the one or more upstream entity collectively represent multiple dependent layers of the production value stream.

15. The method of claim 8, wherein the operational metric corresponding to the respective upstream entity comprise one or more of inventory level, lead time, cost, price, complexity, volume, quality, yield, demand, and reliability.

16. The method of claim 8, wherein the operational metric corresponding to the respective upstream entity comprise historical data reflective of the operational metric corresponding to the respective upstream entity over a time period.

17. The method of claim 8, wherein:
the implementation interface comprises a user interface; and
the response comprise at least one response received via the user interface.

18. The method of claim 8, wherein:
the implementation interface comprises an automated interface; and
the response comprise at least one response received via the automated interface.

19. A non-transitory computer-readable storage medium, the computer-readable storage medium including instructions that when executed by a computer, cause the computer to:
receive, by a causal-analysis machine-learning model for a production value stream of a product, upstream delay predictions from each of a plurality of upstream machine-learning models, each upstream machine-learning model corresponding to a respective upstream entity in the production value stream;
receive, by the causal-analysis machine-learning model, product-throughput prediction from a final-assembly machine-learning model for the production value stream;
identify, by the causal-analysis machine-learning model, and based on at least the received upstream delay predictions and the product-throughput prediction, causal factor for one or both of the upstream delay predictions and the product-throughput prediction;
provide, by the causal-analysis machine-learning model, the identified causal factor to an action-and-alert process for the production value stream;
generate, by the action-and-alert process, and based on at least the identified causal factor, one or both of one or more alerts and one or more recommended actions; and
provide, by the action-and-alert process, the one or both of one or more alerts and one or more recommended actions to an implementation interface for the production value stream.
